(19) United States
(12) Patent Application Publication
(10) Pub. No.: US 2019/0253503 A1
(43) Pub. Date: Aug. 15, 2019

(54) TECHNIQUES FOR SELECTING ADDITIONAL LINKS

(71) Applicant: Branch Metrics, Inc., Redwood City, CA (US)

(72) Inventors: Alexander Austin, Palo Alto, CA (US); Eric J. Glover, Palo Alto, CA (US); Vishwa Ranjan, Sunnyvale, CA (US); Augustus Hong, Cupertino, CA (US); Zeesha Currimbhoy, Sunnyvale, CA (US); John Saleigh, San Jose, CA (US)

(73) Assignee: Branch Metrics, Inc., Redwood City, CA (US)

(21) Appl. No.: 16/270,723

(22) Filed: Feb. 8, 2019

Related U.S. Application Data
(60) Provisional application No. 62/628,588, filed on Feb. 9, 2018.

(51) Int. Cl. H04L 29/08; G06F 16/953

(52) U.S. Cl. CPC H04L 67/18; H04L 67/10; G06F 16/953

(57) ABSTRACT

A method includes receiving a user ID for a user device and entity identification data that indicates an entity. The method includes identifying first and second action links using the entity identification data. The first and second action links are configured to cause the user device to access first and second application states associated with the entity. The first and second action links are associated with first and second action IDs that indicate functionality of the first and second application states. The method includes determining first and second usage values using the user ID. The first and second usage values indicate a number of times the user device accessed application states associated with the first and second action IDs. The method includes scoring the action links based on the first and second usage values, selecting one of the action links based on the scores, and transmitting the selected action link.

### CROSS-REFERENCE TO RELATED APPLICATIONS

This application claims the benefit of U.S. Provisional Application No. 62/628,588, filed on Feb. 9, 2018. The disclosure of the above application is incorporated herein by reference in its entirety.

### FIELD

The present disclosure relates to providing additional linking functionality across multiple computing platforms.

### BACKGROUND

Software developers can develop applications and websites that are accessed by users on a variety of different platforms, such as different computing devices and operating systems. Example applications may include e-commerce applications, media streaming applications, business review applications, social media applications, and news applications. These applications and corresponding websites can provide users with different functionalities for a variety of different entities, such as consumer product entities and digital media entities (e.g., movies/songs). For example, an e-commerce application can provide consumer products for sale to users. As another example, a media streaming application can play movies or songs for a user.

### SUMMARY

In one example, a method comprises receiving, at a server, a request that includes entity identification data that indicates an entity associated with a first application state, wherein the request includes a user identifier (ID) that identifies a user device. The method further comprises identifying a first action link based on the entity identification data. The first action link is configured to cause the user device to access a second application state associated with the entity. The first action link is associated with a first action identifier (ID) that indicates functionality of the second application state. The method further comprises identifying a second action link based on the entity identification data. The second action link is configured to cause the user device to access a third application state associated with the entity. The second action link is associated with a second action ID that indicates functionality of the third application state. The method further comprises determining a first usage value and a second usage value based on the user ID. The first usage value indicates a number of times the user device has accessed application states associated with the first action ID. The second usage value indicates a number of times the user device has accessed application states associated with the second action ID. The method further comprises scoring the first action link and the second action link based on the first usage value and the second usage value, respectively. Additionally, the method comprises selecting one of the first and second action links based on the scores associated with the first and second action links and transmitting the selected action link.

In one example, a system comprises one or more storage devices and one or more processing units. The one or more storage devices are configured to store a first action link and a second action link. The first action link is configured to cause a user device to access a first application state associated with an entity. The first action link is associated with a first action ID that indicates functionality of the first application state. The second action link is configured to cause the user device to access a second application state associated with the entity. The second action link is associated with a second action ID that indicates functionality of the second application state. The one or more processing units are configured to execute computer-readable instructions that cause the one or more processing units to receive a request that includes entity identification data associated with a third application state. The entity identification data identifies the entity and the request includes a user ID that identifies the user device. The one or more processing units are configured to identify the first action link based on the entity identification data, identify the second action link based on the entity identification data, and determine a first usage value and a second usage value based on the user ID. The first usage value indicates a number of times the user device has accessed application states associated with the first action ID. The second usage value indicates a number of times the user device has accessed application states associated with the second action ID. The one or more processing units are configured to score the first action link and the second action link based on the first usage value and the second usage value, respectively. The one or more processing units are configured to select one of the first and second action links based on the scores associated with the first and second action links and transmit the selected action link.

In one example, a method comprises generating, at a search server, a set of search results based on a search request received from a user device. The search request includes a user ID that identifies the user device. One of the search results is a preliminary search result that includes entity identification data associated with an entity. The preliminary search result includes a search result link configured to cause the user device to access a first application state associated with the entity. The method further comprises identifying a first action link based on the entity identification data. The first action link is configured to cause the user device to access a second application state associated with the entity. The first action link is associated with a first action ID that indicates functionality of the second application state. The method further comprises identifying a second action link based on the entity identification data. The second action link is configured to cause the user device to access a third application state associated with the entity. The second action link is associated with a second action ID that indicates functionality of the third application state. The method further comprises determining a first usage value and a second usage value based on the user ID. The first usage value indicates a number of times the user device has accessed application states associated with the first action ID. The second usage value indicates a number of times the user device has accessed application states associated with the second action ID. The method further comprises scoring the first action link and the second action link based on the first usage value and the second usage value, respectively. The method further comprises selecting one of the first and second action links based on the scores associated with the first and second action links. Additionally, the method comprises generating a completed search result by including the selected action link in the preliminary search result and transmitting the set of search results including the completed search result to the user device.

### BRIEF DESCRIPTION OF THE DRAWINGS

The present disclosure will become more fully understood from the detailed description and the accompanying drawings.

FIG. 1 illustrates an environment that includes an action system and an event system.

FIGS. 2A-2B illustrate graphical user interfaces (GUIs) including action links.

FIG. 3 illustrates a plurality of requesting devices in communication with the action system.

FIG. 4 illustrates a method that describes operation of the action system and the requesting devices.

FIG. 5 illustrates an example action request/response that is received/transmitted by the action system.

FIGS. 6A-6B illustrate example entity records.

FIGS. 7A-7B illustrate example action records.

FIGS. 8A-8B illustrate identification of a single entity record using an application-specific entity identifier.

FIGS. 9A-9B illustrate identification of multiple entity records using a global entity identifier.

FIGS. 10A-10B illustrate identification of multiple entity records using request metadata.

FIGS. 11A-11B illustrate identification of multiple entity records and subsequent grouping of entities.

FIG. 12 illustrates the generation of dynamic action links.

FIGS. 13A-13B illustrate example data records for a single user and a plurality of users, respectively.

FIG. 14 illustrates example data used to score action links.

FIG. 15A illustrates an example action scoring module that scores action links.

FIG. 15B illustrates a method for scoring action links.

FIG. 16A illustrates an example search server that includes the action system.

FIG. 16B illustrates a method for generating search results including action links.

In the drawings, reference numbers may be reused to identify similar and/or identical elements.

### DETAILED DESCRIPTION

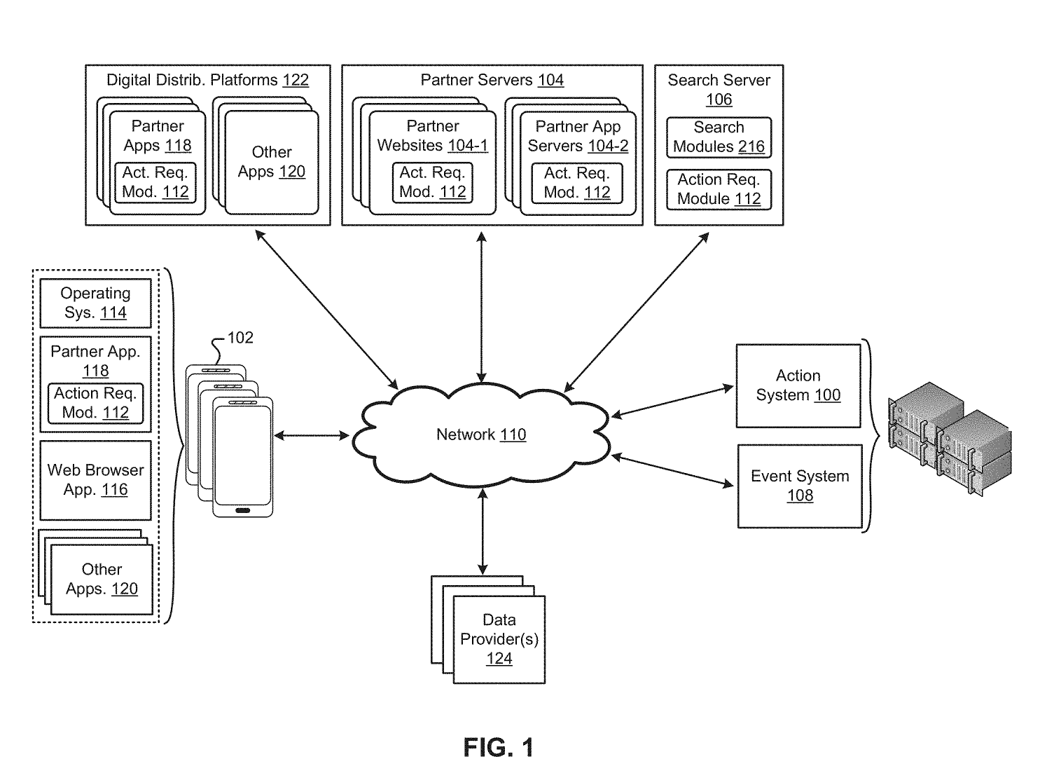

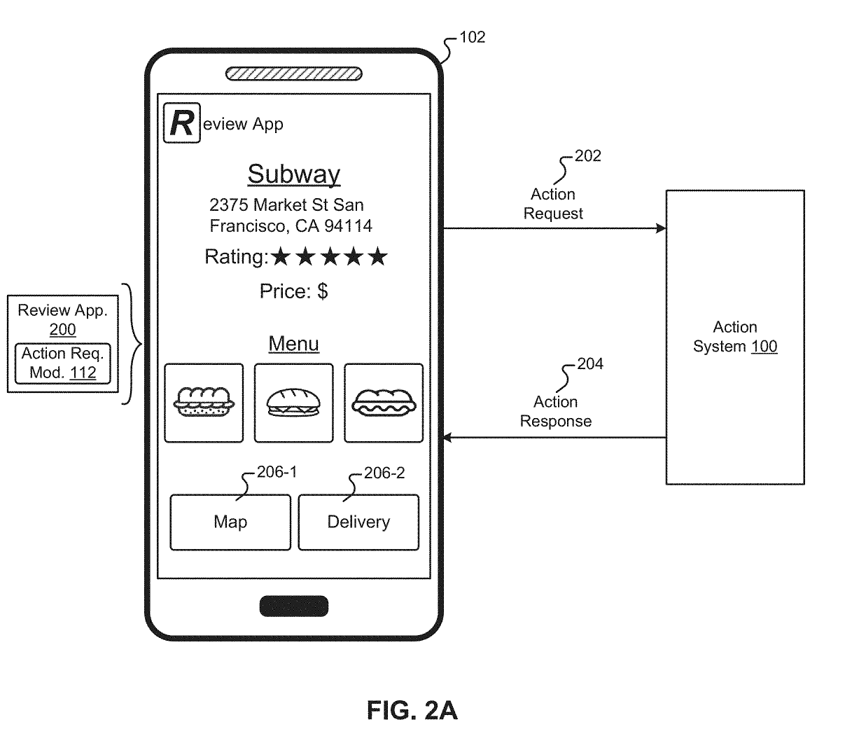

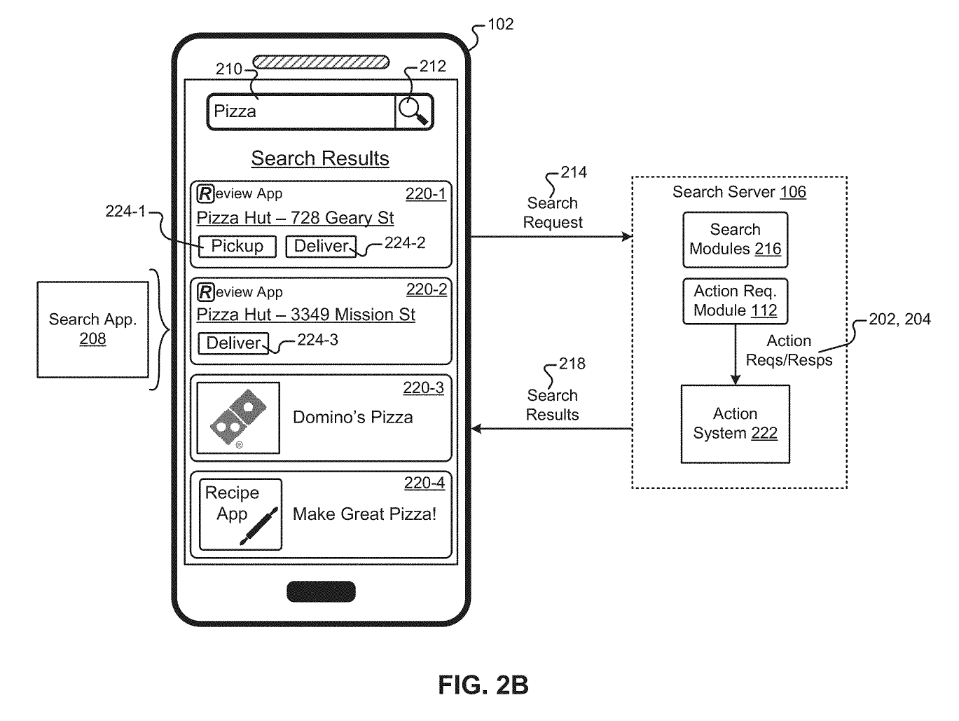

An action system 100 (e.g., one or more servers) of the present disclosure can provide action links to requesting computing devices, such as user computing devices 102 (e.g., smartphones) and server computing devices 104, 106 (e.g., see FIG. 1). The action links may be user-selectable links that are rendered in applications/websites being accessed on user computing devices 102 (e.g., see FIGS. 2A-2B). For example, the action links may include application uniform resource locators (e.g., URLs) that access application states. The rendered action links may provide additional actions associated with the currently accessed content. Selection of an action link may cause the user computing device 102 to perform additional actions that are relevant to the currently accessed content.

In one example, a user computing device 102 (hereinafter “user device 102”) can send an action request to the action system 100 in response to accessing a state (e.g., a page) of an application installed on the user device 102. The action request may be a request for one or more additional action links associated with currently accessed content. For example, the action request can include entity identification data (e.g., an entity ID) that indicates an entity (e.g., person, place, or thing) associated with the currently accessed state. In response to the action request, the action system 100 can identify a set of action links that access application states associated with the currently accessed content (e.g., entity). The action system 100 can score and/or filter the set of action links and send one or more of the action links to the user device 102 for rendering. In some examples, the action system 100 may score/filter the action links based on user event data indicating how the user has interacted with various applications and actions in the past.

A user may access a variety of different application states in an application. An application state may refer to a page of an application. Example applications may include, but are not limited to, e-commerce applications, social media applications, business review applications, banking applications, gaming applications, and weather forecast applications. Similarly, a user may also access such functionality on different webpages of corresponding websites.

Different application states and webpages may be associated with different entities. An entity may refer to a person, place, or thing. For example, an entity may refer to a business, product, public figure (e.g., entertainer, politician, etc.), service, media content (e.g., music, video, etc.), or point of interest. In a specific example, if an e-commerce application includes an application state that sells a particular pair of shoes, the pair of shoes may be the entity that is associated with the application state. In another specific example, if a music streaming application provides an application state that plays a particular song, the song may be the entity that is associated with the application state.

Applications and websites can provide a variety of different actions. An action may refer to one or more terms (e.g. words) that describe what the application state or webpage provides to the user when accessed. For example, an action may be descriptive of the functionality provided by the accessed application state or webpage. Example actions may include, but are not limited to: Navigate to a location, Provide map, Find transportation, Provide information, Order food for pickup/delivery (e.g., from a restaurant), Reserve a table, Show photos, Show menu, Provide reviews (e.g., for businesses), Check stock prices, Check weather, Check sports scores, Play music, Play movie, Listen to radio station(s), and Provide discount.

Applications/websites can provide one or more actions. In some cases, a single application/website can provide a single action. For example, a mapping application may be limited to providing maps to locations. In this example, each application state may be a map from one location to another location. In other cases, a single application/website can provide multiple actions. For example, a restaurant reservation application that provides reservation actions for restaurants may also provide reviews and menus for the restaurants. In some cases, each application state can provide a single action. For example, in the restaurant reservation application, some states may provide reservation functionality, while other states provide reviews. In some cases, a single application state can provide multiple different actions. For example, in the restaurant reservation application, a single state may provide both reviews and reservation functionality.

The following are some example applications and some example associated actions. The YELP® application developed by Yelp, Inc. may provide reviews for businesses, maps to businesses, and photos for businesses, among other actions. The TRIPADVISOR® application developed by TripAdvisor, Inc. may provide similar actions as the YELP® application along with providing deals for businesses (e.g., hotel deals). The OPENTABLE® application developed by OpenTable, Inc. may provide restaurant reservation actions. The EAT24® application developed by Grubhub Inc. may provide food delivery actions. The IMDB® application developed by Amazon.com, Inc. may provide movie reviews, provide movie information, and play movie trailers.

The action system 100 provides additional functionality to applications and websites by providing action links to the applications/websites that may be different (e.g., additional) than those provided by the applications/websites themselves. For example, an application state for a restaurant entity can benefit from a delivery action link (e.g., see FIG. 2A). As another example, a search engine result page can benefit from additional action links for each of the search results (e.g. see FIG. 2B).

Application developers and users can benefit from the addition of action links in applications and websites. For application developers, the action links can provide a convenient way to implement additional functionality in their applications/websites. The added functionality provided by the action links can improve a user's experience in the applications/websites by providing the user with more functionality in a single location. Furthermore, the action links can be personalized based on user preferences for specific applications and actions, which may improve action link relevance for the users. The additional functionality and personalized nature of the action links may serve to attract and retain more users on developers' applications and websites.

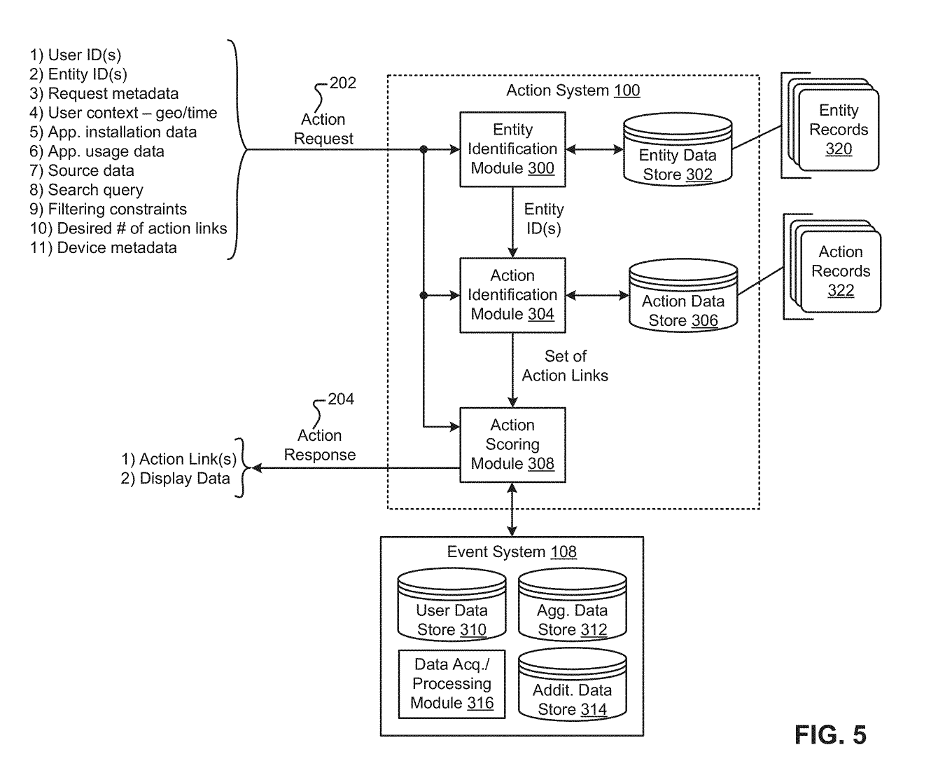

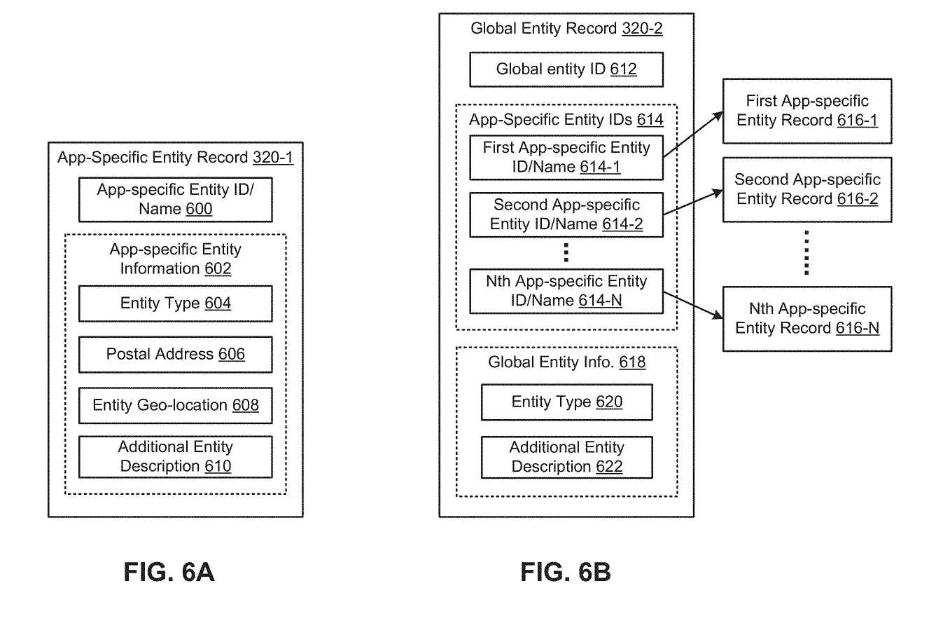

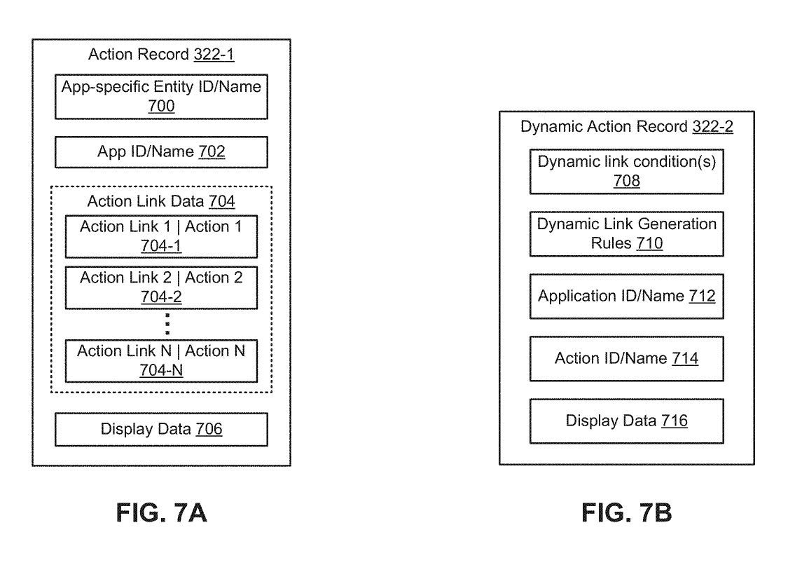

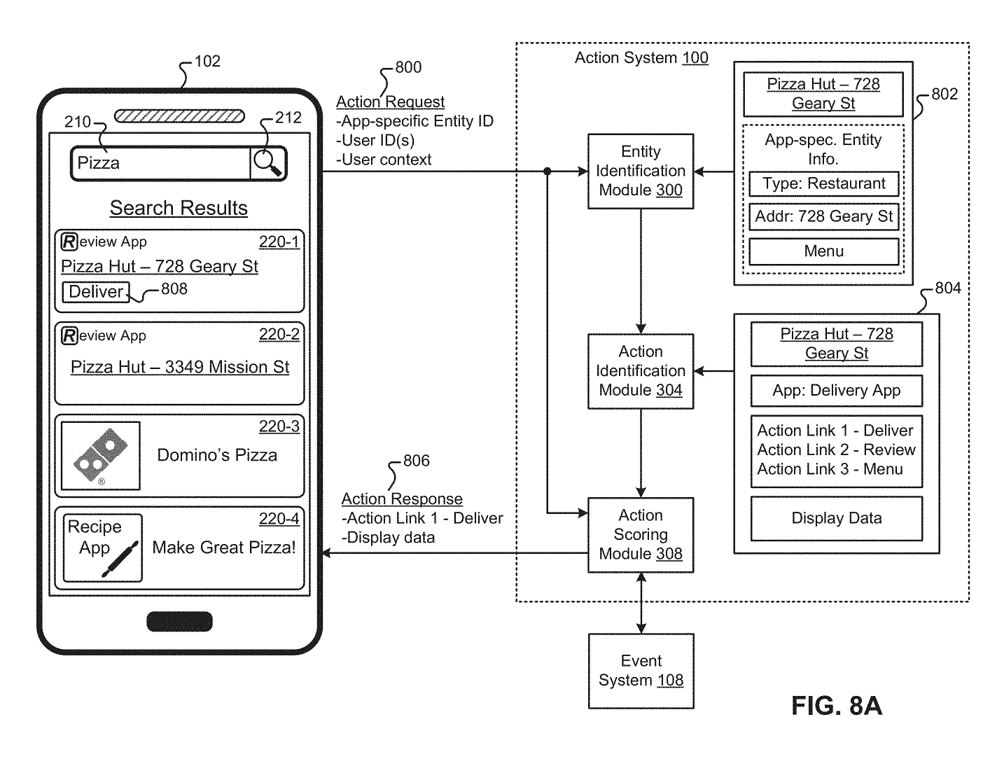

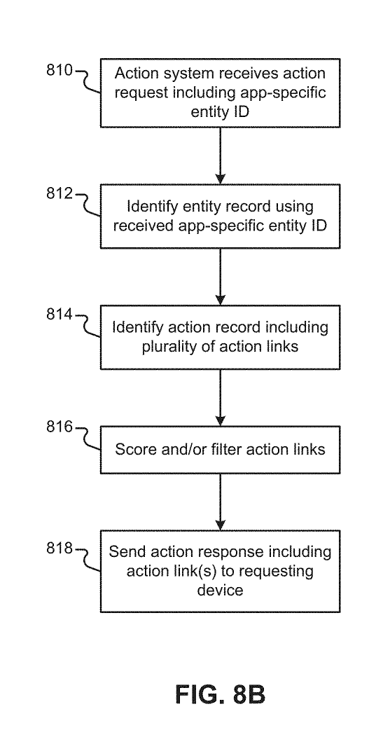

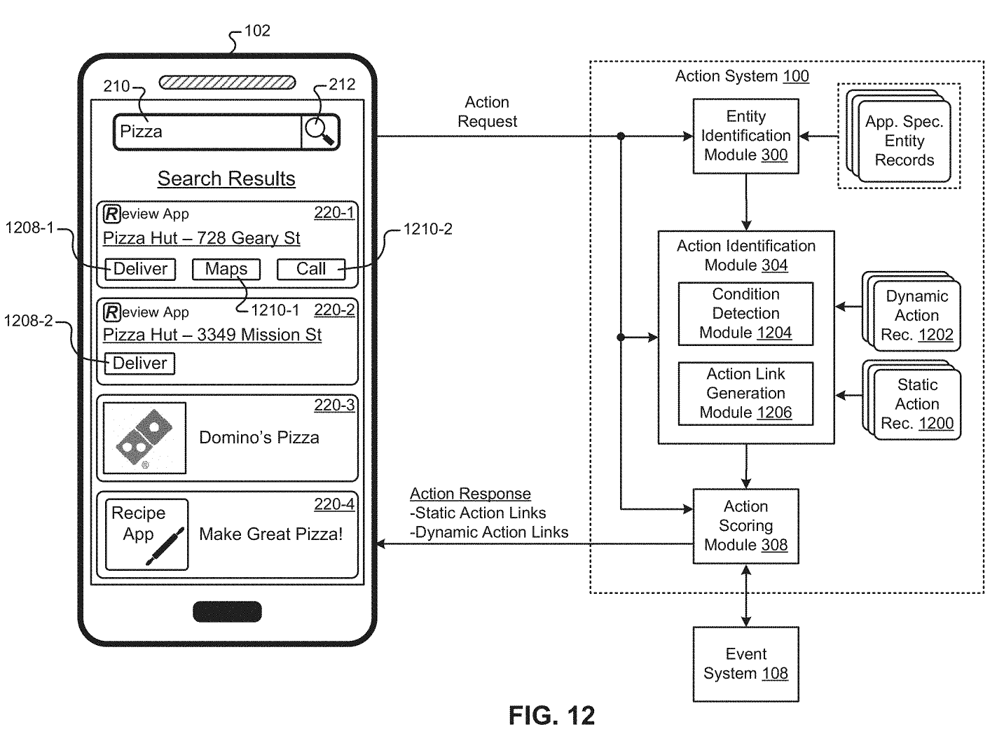

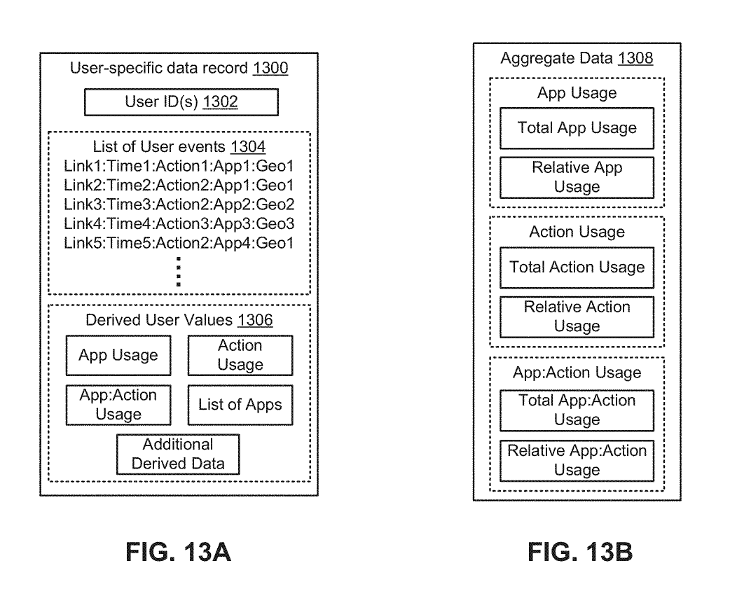

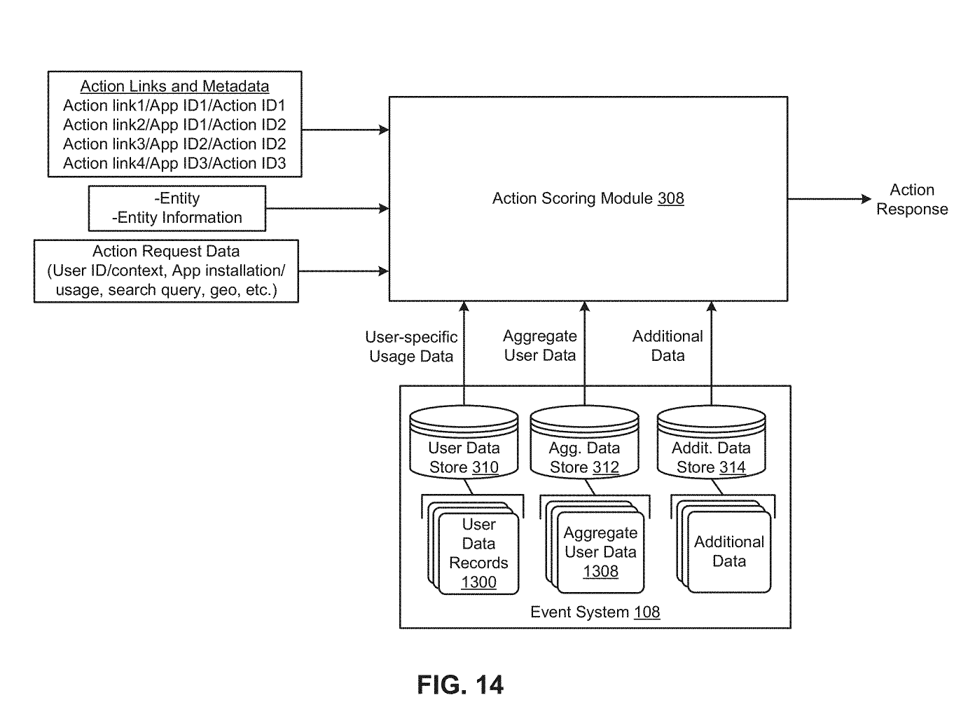

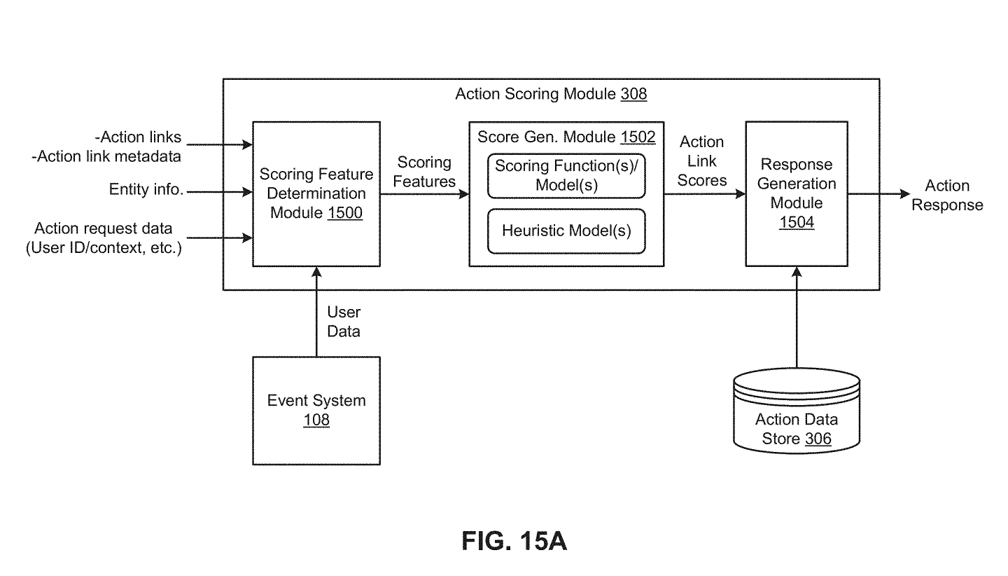

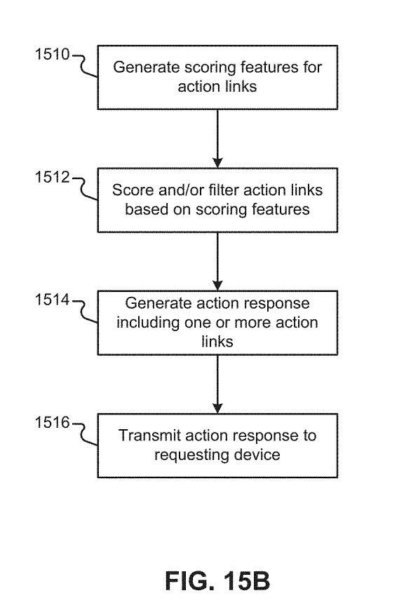

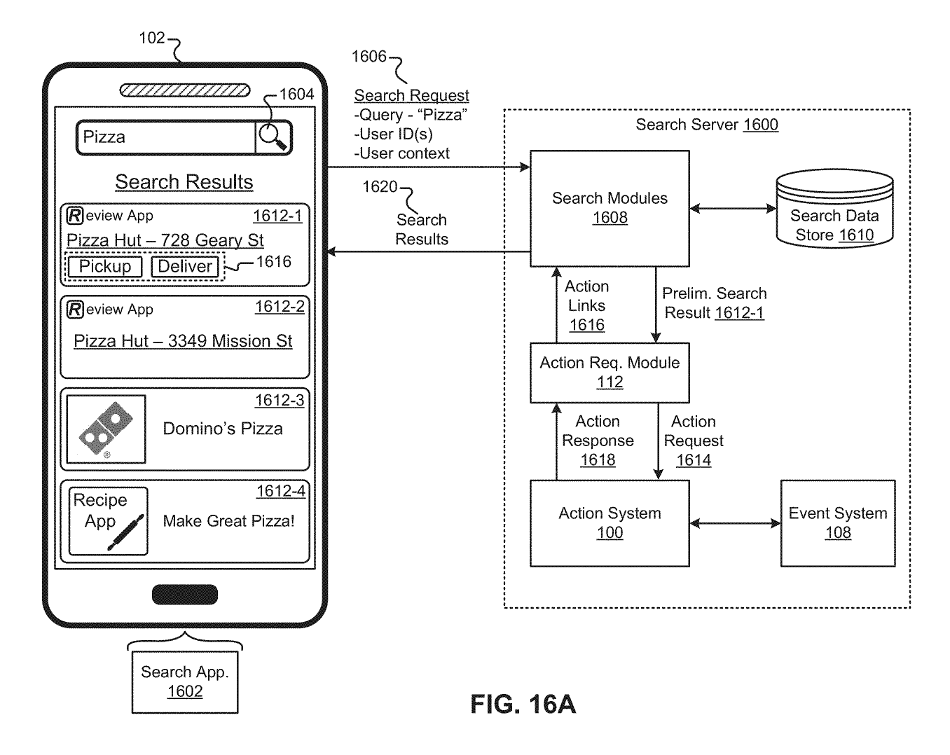

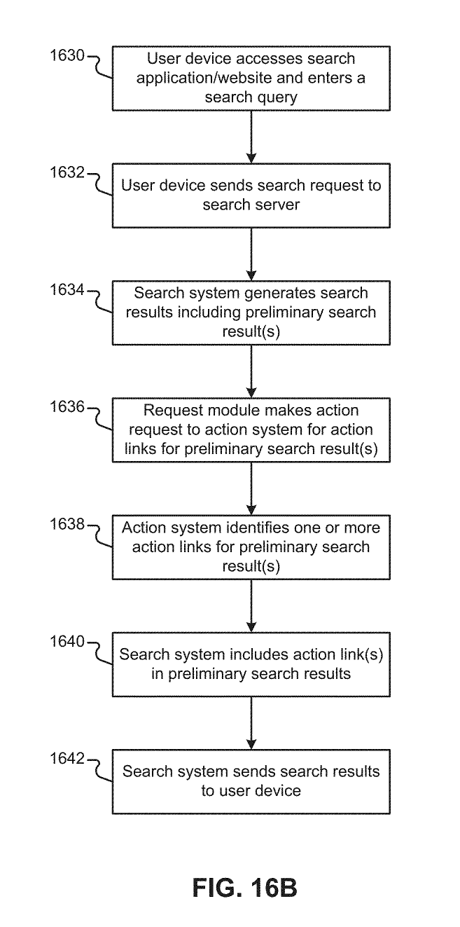

FIGS. 1-16B illustrate example aspects of the action system 100. FIG. 1 and FIGS. 3-4 illustrate an action system 100 in communication with other devices/servers. FIGS. 2A-2B illustrate example GUIs including action links. FIG. 5 illustrates an example action request and response. FIGS. 6A-7B illustrate example data records for entities and action links in the action system 100. FIGS. 8A-11B describe aspects of entity identification at the action system 100. FIG. 12 illustrates generation of an action link according to a dynamic action record. FIGS. 13A-13B illustrate example data structures that store user data and other data that the action system may use for scoring and/or filtering action links. FIGS. 14-15B describe aspects of scoring action links. FIGS. 16A-16B describe operation of a search server that includes the action system.

FIG. 1 illustrates an example environment that includes the action system 100 in communication with a plurality of user devices 102, partner servers 104 (e.g., partner websites 104-1 and partner application servers 104-2), and a search server 106. The action system 100 can provide action links to the user devices 102, partner servers 104, and the search server 106. The event system 108 (e.g., one or more servers) may provide data (e.g., user data) to the action system 100 for scoring/filtering the action links. The devices 102 and servers 100, 104, 106, 108 can communicate with one another via a network 110. The network 110 may include various types of computer networks, such as a local area network (LAN), wide area network (WAN), and/or the Internet.

In some implementations, a single party (e.g., a business) can own/operate the action system 100 and the event system 108. In these implementations, the single party can provide the functionality of the action system 100 and the event system 108 to various partners. The partners (e.g., businesses) may use the functionality of the action system 100 to include action links in their applications/websites. Although the action system 100 and event system 108 may be operated by a single party for use by one or more partners, in some cases, the action system 100 and the event system 108 may be operated by different parties.

The owner/operator of the action system 100 can provide an action request module 112 (hereinafter “request module 112”) to partners for inclusion in partners' applications/servers. The request module 112 can generate and transmit the action requests to the action system 100. The request module 112 may also be configured to render the received action links. In some implementations, the request module 112 may provide additional functionality, such as filtering (e.g., client-side filtering of action links for applications not installed on the user device 102).

The request module 112 can be configured by the action system operator and/or the partners. The partners can integrate the request module 112 in a variety of ways. For example, a partner can retrieve request module components that the partner can modify and include into their application(s) and server(s). The request module components can include computer code that provides features for communicating with the action system 100. For example, the request module components may include features for generating action requests and sending the action requests to the action system 100. A computing device that uses the request module 112 to make requests to the action system 100 may be referred to herein as a “requesting computing device” or a “requesting device.”

An example partner may be an application developer or other business that provides a native application for installation on a user device 102. Another example partner may be a business that operates a server (e.g., a partner web/app server 104) that provides websites and/or data for applications installed on the user device 102. In a specific example, a partner may operate a search server 106 that includes the request module 112. In this example, the search server 106 can include action links in search engine result pages accessed by the user devices 102.

A user device 102 may include an operating system 114 and a plurality of applications, such as a web browser application 116 and additional applications (e.g., partner applications 118 and/or other applications 120). Using the web browser 116, the user device 102 can access various websites on the partner servers 104 via the network 110. A user device 102 may also execute a partner application 118 that includes a request module 112. The partner application 118 may include, but is not limited to, any type of application described herein (e.g., an e-commerce application or business review application). In one example, the partner application 118 may be a launcher application that provides a GUI for a user device, such as a home screen GUI and other screens including application icons and application widgets. The launcher application may assist the user in finding applications/links to open on the user device. In some implementations, the request module 112 may be integrated into the operating system 114.

A user device 102 can download applications from digital distribution platforms 122 via the network 110 and install the applications. The digital distribution platforms 122 represent computing systems that are configured to distribute applications to user devices 102. Example digital distribution platforms 122 include, but are not limited to, the GOOGLE PLAY® digital distribution platform by Google, Inc. and the APP STORE® digital distribution platform by Apple, Inc. The digital distribution platforms 122 include one or more partner applications 118, each of which may include a request module 112. The digital distribution platforms 122 also include a plurality of other applications 120 developed by parties other than the partners.

The event system 108 can store user data for a plurality of user devices 102 (e.g., see user-specific data record 1300 of FIG. 13A). For example, the event system 108 can store lists of past user events 1304 for a plurality of different users (e.g., user devices 102). Example user events may include, but are not limited to, accessing application states and/or webpages, opening applications, closing applications, and installing applications. The event system 108 can store data associated with each event, such as an event type, a link (e.g., URL) associated with the event, an action ID for the event, an application ID associated with the event, and a geolocation of the user.

The event system 108 can collect user data in a variety of ways. In some implementations, user devices may include modules (not illustrated) that acquire and report user event data. For example, the owner/operator of the action system 100 can provide modules that report user events back to the event system 108. In another example, application developers can collect user event data and provide the data to the event system 108. In another example, a third-party data provider (e.g., other than the event system 108 and application developers) can provide modules that acquire and report the user event data back to the third party. In this example, the third party may provide data to the event system 108. The data providers 124 of FIG. 1 represent any data provider (e.g., application developer or third party) that provides event data to the event system 108.

The event system 108 includes a data acquisition and processing module 316 (hereinafter “data processing module 316”) that acquires and processes the event data. For example, the data processing module 316 can acquire the user event data (e.g., list of user event data) and generate additional values for the user event data (e.g., derived user values 1306). The data processing module 316 can also generate other data for the event system 108, such as aggregate data that indicates how a plurality of users use applications and actions. For example, the data processing module 316 can generate aggregate data based on the user data stored for a plurality of users (e.g., see aggregate data of FIG. 13B). In some implementations, the event system 108 can also include additional data regarding applications, such as application popularity metrics (e.g., download numbers) and application quality metrics (e.g., application ratings).

The action system 100 can use the data included in the event system 108 to score and filter action links. For example, the action system 100 can score/filter action links for a user device based on the applications installed on the user device and how the user uses the applications/websites. In a specific example, the action system 100 can score/filter action links based on a user's relative usage of applications and associated actions. The action system 100 may also score/filter action links based on the aggregate data and additional data included in the event system 108. In this manner, the action system 100 can provide users with relevant and personalized action links.

FIGS. 2A-2B illustrate example GUIs on a user device 102. In FIG. 2A, the user device 102 is executing a partner application that includes a request module 112. For example, the user device 102 is accessing an application state (e.g., page) for a review application 200. Specifically, the user device is accessing an application state for a SUBWAY® restaurant entity at 2375 Market St. in the Review App. The Review App may be representative of an application that provides reviews of businesses. The illustrated application state includes an address, rating value, price indicator, and links to items on the menu (e.g., sandwiches).

The request module 112 may have generated and transmitted an action request 202 in response to accessing the application state. The action system 100 provided an action response 204 to the user device 102 that included two action links, which are rendered in FIG. 2A. The two action links 206-1, 206-2 are for mapping and delivery actions. The map action link 206-1 may access a map application state that provides a map to the SUBWAY® restaurant from the user's current location. The delivery link may access an application state that provides delivery from the SUBWAY® restaurant. For example, the application state may be a state in a delivery application that provides food delivery.

The rendered action links 206-1, 206-2 are rendered as GUI button elements including text that indicates the associated actions. Although the action links 206-1, 206-2 are rendered as GUI buttons including text in FIG. 2A, in other examples, the GUI buttons may be rendered in other manners, such as hyperlinks or as more detailed GUI elements that include images and additional text, such as application icon images, descriptive text, and/or images and text from the application state accessed via the action link. The user may select (e.g., touch/click) the rendered action links 206-1, 206-2 to access the resources (e.g., application states) associated with the action links 206-1, 206-2. For example, selecting an action link can cause the associated application to launch and access the application state specified by the action link.

In some implementations, action links may be for applications other than the application associated with the action request. For example, the action links may be for applications other than the application state being accessed on the user device. As another example, action links may be for applications other than the application associated with a search result link into which the action link is included. Although the action links may be included in applications other than the application associated with the action request, in some implementations, the action links may be for the same application that is associated with the action request. In these implementations, the action system 100 may be used (e.g., by a partner) to provide a better scoring/filtering solution than the requesting application can provide.

FIG. 2B illustrates a user device 102 that includes a search application 208. The search application 208 receives a user's search query “Pizza” in a search box 210. The user can execute the search by pressing the search GUI element 212. In response to selecting the search GUI element 212, the user device 102 sends a search request 214 to the search server 106. The search request 214 can include the search query “Pizza” and other data, such as a user's geolocation and user identifier (ID).

The search server 106 performs a search based on the search query and additional search query data. The search server 106 includes search modules 216 that perform the search. For example, the search modules 216 may crawl and index information (e.g., application states and/or webpages) for retrieval. The search modules 216 can process the received search query and provide search results 218 including links into applications/websites. For example, the search results 218 of FIG. 2B include 1) a link 220-1 to the PIZZA HUT® restaurant at 728 Geary St. in the Review App, 2) a link 220-2 to the PIZZA HUT® restaurant at 3349 Mission St. in the Review App, 3) a link 220-3 that opens the DOMINOS PIZZA® Application, and 4) a link 220-4 in a Recipe App for making great pizza. Although the links 220 illustrated in FIG. 2B are for applications, in some implementations, the search results may include other types of search result links, such as web links and/or links to download applications.

The search server 106 of FIG. 2B includes a request module 112 and the action system 222. The action system 222 may include similar functionality as the action system 100. In FIG. 2B, a single party may operate the search server 106 including the action system 222. After the search modules 216 perform the search and identify a preliminary set of search results (e.g., links 220), the request module 112 can make an action request 202 to the action system 222 for additional action links for one or more of the preliminary search results. The search results that receive action links, along with the number of action links for each result, can be configured at the search server 106. For example, the request module 112 may specify which search results get action links and/or the number of action links to insert into the specific search results.

In FIG. 2B, the action system 222 provides action links 224-1, 224-2, 224-3 for search results 220-1, 220-2. For example, the action system 222 provided action links for “Pickup” 224-1 and “Deliver” 224-2 for the first search result link 220-1. The action link 224-1 may access an application state that allows the user to order pizza for pickup at PIZZA HUT® at 728 Geary St. The action link 224-2 may access an application state that allows a user to have pizza delivered from PIZZA HUT® at 728 Geary St. The action system 222 also provided an action link for “Deliver” 224-3 for the second search result link 220-2. As described herein, the pickup/deliver action links 224 may have been selected by the action system 222 based on the user's past events, the user's current context (e.g., geolocation), and/or time of day. The user can select (e.g., touch/click) the action links 224 to access the corresponding application states. The user may also select the search result links 220 (e.g., the area around the action links) to access the corresponding application states.

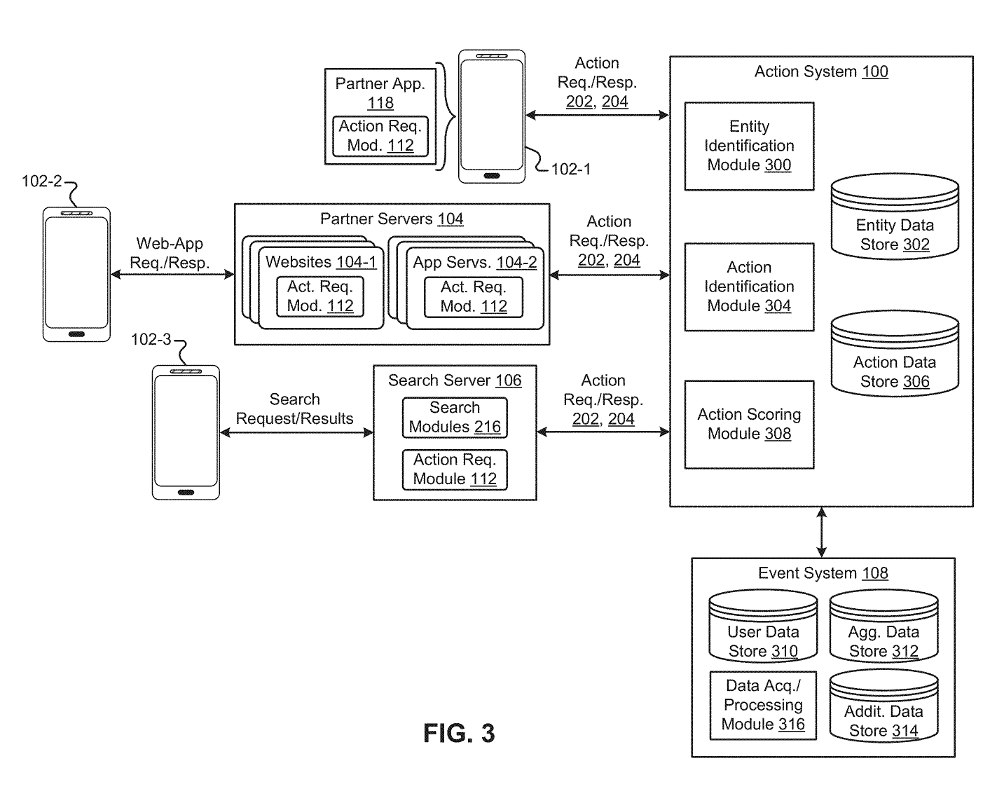

FIG. 3 illustrates a variety of different requesting devices 102, 104, 106 requesting action links from the action system 100. For example, a user device 102-1 executing a partner application 118 including a request module 112 generates an action request 202. The generation and transmission of the action request 202 can be triggered in a variety of manners. The triggers for generating and transmitting an action request may vary, depending on the type of partner application on the user device. In one example, the request module 112 may automatically generate and transmit an action request in response to a user accessing an application state or webpage. In another example, the request module 112 may automatically generate and transmit an action request in response to a user accessing a specific screen on the user device (e.g., a home screen or other screen of a launcher application). In some examples, an action request may be triggered by receiving a set of predicted entities which the user may find interesting. For example, a calendar application may request/receive action links to help the user get to a location of a user's meeting. As another example, an action request may be triggered to push action links to a user based on anticipated engagement, such as for an e-mail advertisement or other advertisement (e.g., a pop-up).

The action request 202 may be a request for one or more additional action links associated with currently accessed content (e.g., the currently accessed entity). The action requests 202 can include entity identification data (e.g., an entity ID and/or request metadata) that identifies an entity associated with the application state. The action requests 202 may also include additional data, such as one or more user IDs, user context (e.g., geo and time of day), and/or other data described herein (e.g., see FIG. 5). The action system 100 can identify action links based on the action request 202 and subsequently transmit an action response 204 that includes one or more action links along with display data for rendering the action links on a user device 102.

FIG. 3 illustrates partner servers 104 including request modules 112 that send action requests 202 to the action system 100. The partner web and application servers 104 may provide websites and application data (e.g., for display in an application state) to the user device 102-2. In these examples, the user device 102-2 can request data from the partner servers 104 (e.g., request a web page or application data). In response to receiving a request for data (e.g., a Hypertext Transfer Protocol request) from the user device 102-2, the partner servers 104 can send an action request 202 to the action system 100. In these examples, the partner servers 104 can include the action links in the content (e.g., webpage or application data) transmitted back to the user device 102-2. In some implementations, instead of making action requests to the action system 100 in response to interactions with user devices, the partner servers 104 can pre-populate webpage and application data with action links prior to interaction with user devices.

FIG. 3 illustrates an example search server 106 in communication with a user device 102-3 and the action system 100. In FIG. 3, the user device 102-3 makes a search request to the search server 106. The search server 106 may generate preliminary search results based on the received search request (e.g., a search query), and then make an action request to the action system 100 for action links that can be included with the search results (e.g., see FIG. 2B). The search server 106 can include the received action links into the preliminary search results and send the search results to the user device 102-3. The request module 112 may be implemented in a variety of ways, depending on where the request module 112 is integrated. For example, the request module 112 may be implemented as a software development kit (SDK) library in an application, JavaScript embedded into a webpage, or custom code configured to send entity data to the action system's API.

In some implementations, the action system 100 may also be leveraged by another system, such as an advertisement system (not illustrated). In these implementations, the advertisement system may provide advertisements (e.g., banners) to users in search results, web pages, and/or application states. Some advertisements may be included as action links. In some implementations, the action system 100 may be used to filter for applications where there is a deal (e.g., an advertiser deal). For example, in an advertisement implementation, if an application developer offers to pay for application downloads/engagements, the action system 100 may be configured to yield action links for their application.

An example action system 100 can include an entity identification module 300 and an entity data store 302. The entity identification module 300 identifies one or more entities in the entity data store 302 based on the action request. For example, the entity identification module 300 can identify entity records 320 (e.g., see FIG. 5), such as application-specific entity records 320-1 (e.g., see FIG. 6A), included in the entity data store 302 based on data included in the action request. Application-specific entity records 320-1 may be referred to herein as “app-specific entity records.” An app-specific entity record may include data associated with an entity in a specific application.

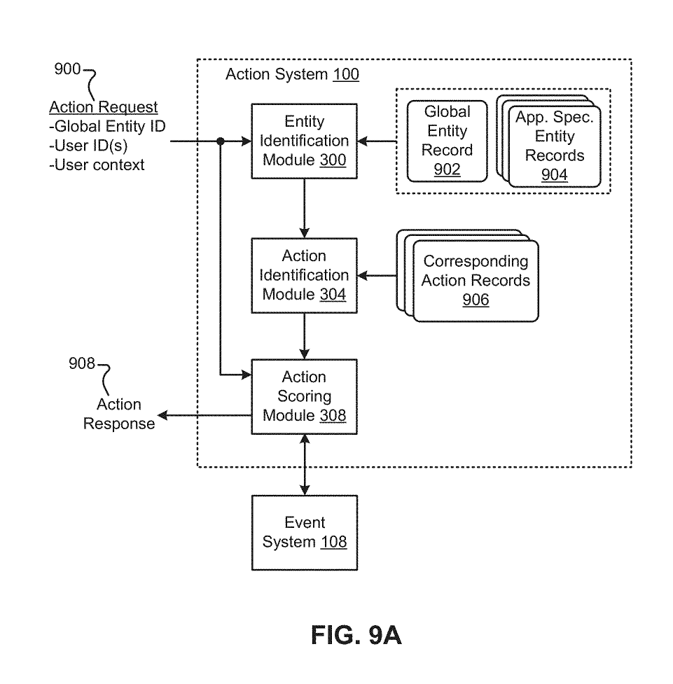

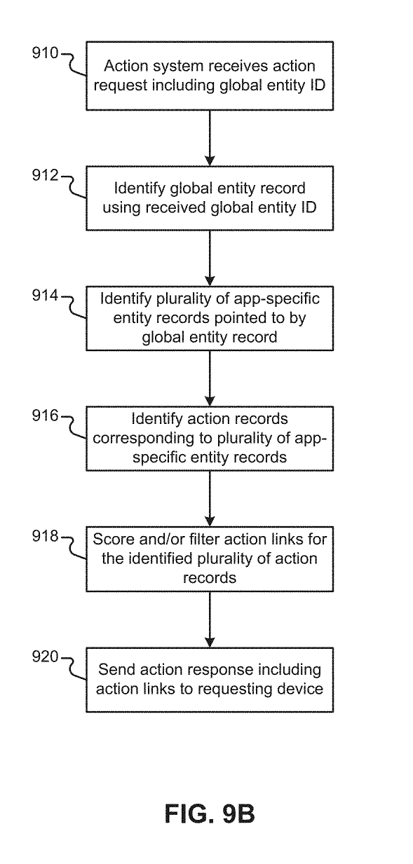

The entity identification module 300 can identify app-specific entity records in a variety of ways (e.g., see FIGS. 8A-11B). In one example, the action request can include app-specific entity IDs that the action identification module 300 can use to directly identify app-specific entity records (e.g., see FIGS. 8A-8B). In another example, the action request can include request metadata that is descriptive of an entity. In this example, the entity identification module 300 can identify app-specific entity records based on matches between the request metadata and the entity information included in the app-specific entity records (e.g., see FIGS. 9A-9B). In some implementations, the entity data store 302 may include global entity records 320-2 (e.g., see FIG. 6B) that point to a plurality of different app-specific entity records that are each associated with the same entity. In these implementations, the entity identification module 300 can identify app-specific entity records by first identifying the global entity records by using a global entity record ID and/or request metadata included in the action request.

The action system 100 includes an action identification module 304 and an action data store 306. The action identification module 304 identifies one or more action links based on the identified entities. For example, the action identification module 304 can identify action records 322 (e.g., see FIGS. 7A-7B) in the action data store 306 based on the identified entity records. The action records 322 may include one or more action links associated with an app-specific entity. The action records may also include metadata associated with each of the action links. Example metadata may include an action ID that identifies the action associated with the action link. Additional example metadata can include an application ID that identifies the application associated with the action link. The action record may also include display data that may be used for rendering the action links on a user device.

In some cases, the action identification module 304 can generate action links in response to the action request. For example, the action identification module 304 can identify dynamic action records 322-2 (e.g., FIG. 7B) in the action data store 306 based on data included in the action request and/or the identified entity records.

The action system 100 includes an action scoring module 308 that can score and/or filter the identified and/or generated action links. In some implementations, the action scoring module 308 can score/filter the action links based on data included in the event system 108, such as user-specific data, aggregate data, and/or additional data (e.g., see FIGS. 13A-13B). The action scoring module 308 can score/filter the action links based on a variety of factors, such as: 1) applications installed on the user device, 2) user engagement data (e.g., past app/web usage) indicating the user's relative application and action usage, 3) aggregate user data, 4) user context (e.g., geolocation), 5) time of day, and/or 6) additional data (e.g., application popularity and ratings). The action scoring module 308 may generate and transmit an action response including the scored/filtered action links and display data. The user-specific data, aggregate user data, and additional data may be stored in the user data store 310, aggregate data store 312, and additional data store 314, respectively.

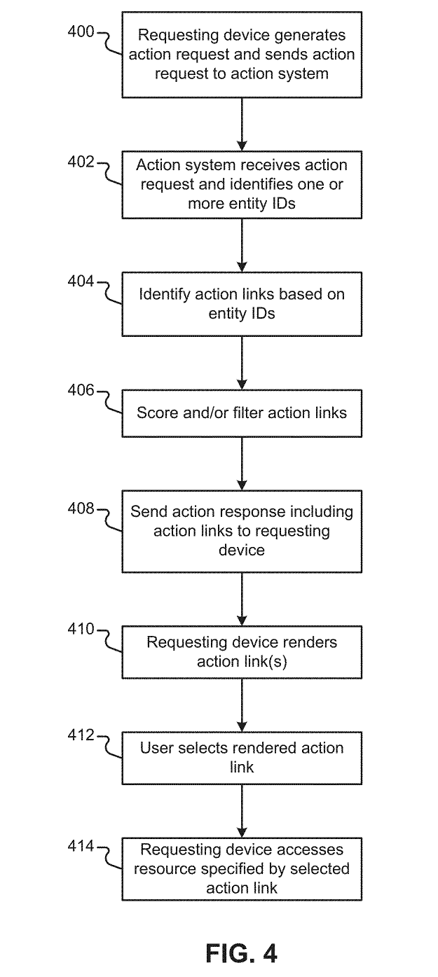

FIG. 4 illustrates an example method that describes operation of the environment of FIG. 1. In block 400, the requesting device (e.g. the request module 112) generates an action request and sends the action request to the action system 100. In block 402, the action system 100 (e.g., the entity identification module 300) receives the action request and identifies one or more entity IDs (e.g., entity records) based on the received action request. In block 404, the action system 100 (e.g., action identification module 304) identifies action links associated with entity IDs. In some implementations, the action identification module 304 can generate action links based on identified dynamic action records (e.g., see FIG. 7B and FIG. 12).

In block 406, the action system 100 (e.g., the action scoring module 308) can score and/or filter the action links. In block 408, the action system 100 sends an action response to the requesting device. The action response can include one or more of the scored action links along with additional data, such as display data and action link metadata (e.g., action ID and application ID). In block 410, the requesting device renders the received actions links. In block 412, the user selects one of the rendered action links. In response to selection of the rendered action link, the requesting device accesses the resource (e.g., application state or website) specified by the action link in block 414.

In some cases, the requesting device can make a single action request for action links associated with a single entity. For example, a user device can request multiple action links for insertion into an accessed application state or website associated with a single entity. In other cases, the requesting device can make multiple action requests for a single application state, such as when the application state includes multiple entities. For example, a user device can access an application state or webpage that includes multiple entities (e.g., a search result page of FIG. 2B). In this example, the user device can generate a single action request for multiple different entities (e.g., each search result may be associated with a different entity).

FIG. 5 illustrates an example action system 100 that receives an action request 202 and generates an action response 204. The action request 202 may include a variety of different types of data. The request module 112 can be configured to generate the data included in the action request 202. As such, an action request may include some/all of the data described as being included in an action request herein. In some implementations, the action request may be implemented as an (application programming interface) API request. In implementations where the action system 100 is included in a system that is owned/operated by a single party (e.g., a search system), the action request may be implemented as a function call and/or microservice.

The action request 202 may include one or more user IDs (e.g., different IDs for the same user/device). Example user IDs may include device identifiers (hereinafter “device IDs”) that identify the user device. For example, device IDs may include a string of alphabetic, numeric, and/or symbolic characters (e.g., punctuation marks) that can be used to identify (e.g., uniquely identify) a user device among other user devices. Some device IDs may be associated with a web browser on a user device (e.g., set by a web browser). Device IDs associated with the web browser may be referred to herein as “web IDs.” Example web IDs may include browser cookie IDs, which may be referred to as web cookies, internet cookies, or Hypertext Transfer Protocol (HTTP) cookies.

Some device IDs may be associated with applications installed on the user device other than the web browser. In some cases, the device IDs may be operating system generated IDs that installed applications may access. Additional example device IDs may include advertising IDs, which may vary depending on the operating system on the user device. Example advertising IDs may include Apple, Inc.'s Identifier for advertising (IDFA) which may be used on devices running IOS®, or Google, Inc.'s Google Advertising ID (GAID) which may be used on devices running the ANDROID® OS. Another example device ID may be a hardware device ID (e.g., a unique device serial number). Although example device IDs described herein may include web device IDs, advertising IDs, and hardware IDs, the techniques of the present disclosure may be applicable to other types of IDs that can be used to uniquely identify a user device. In some implementations, the user ID may include user identification data that identifies a user. User identification data may include a username/login. In some cases, the username may include an email address. The user identification data may identify a user/device with respect to a website/application. In one specific example, the username and application ID pair may identify a user uniquely with respect to the application/website associated with the application name/ID. The event system 108 can use the various user IDs for tracking events on user devices and identifying user-specific data at action request time.

The action request 202 may include one or more app-specific entity IDs and/or one or more global entity IDs. For example, an action request from an application can send an app-specific entity ID associated with the currently accessed content. As another example, if a single party implements the action system 222 in a search server 106, the request module 112 may provide the action system 222 with one or more global entity IDs.

The action request 202 may include request metadata. The request module 112 may be configured to generate the request metadata. For example, the request module 112 may be configured to acquire the request metadata from the currently accessed application state or webpage, such as a title, description, address, and/or phone number present in the accessed application state or webpage. In a more specific example, an application state for a specific restaurant can include a restaurant title, a restaurant description, a restaurant address, a restaurant phone number, and reviews. The request metadata may vary, depending on the type of entity. For example, for point of interest (POI) entities, the request metadata may include a location (e.g., geolocation and/or postal address), a name, and/or a web URL, along with other request data. As another example, for non-POI music-related entities, the request metadata may include a musician name, a song name, and an album name. As another example, for a non-POI movie name, the request metadata may include a movie name, release data (e.g., release year), and movie runtime. In some implementations, the request metadata may indicate an entity type, such as a business, restaurant, famous person, or airport code.

The action request 202 can include user context data, such as a geolocation (e.g., geocoordinates), a user's locale (e.g., country and city), and timing data (e.g., local time of day and date). In some implementations, the user context data can include other information, such as if the user is at home or away, if the user is driving or walking, or if the user is on a cellular network or a Wi-Fi connection.

The action request 202 can include application installation data that indicates applications that are installed on the user device. The action system 100 may also determine which applications are installed on the user device based on user data included in the event system 108.

The action request 202 can include application usage data that indicates how the user has used one or more applications on the user device. In some examples, the application usage data can include usage data for the requesting application and/or other applications installed on the user device. The application usage data can include similar data described with respect to the user data records (e.g., see FIG. 13A). The user data received in the action request 202 can be used along with, or instead of, the event system user data.

The action request 202 can include source data that indicates the source of the action request 202. For example, the source data may indicate the application that generated the action request 202. In a specific example, the source data may include an application ID that identifies the source of the action request. In another example, the source data may indicate the application state that is being accessed on the user device.

The action request 202 may include a search query that was entered by the user. For example, the search query in the action request 202 may be a search query entered by a user into a search box in an application (e.g., a search application) (e.g., see FIG. 2B).

The action request 202 can include filtering constraints. The filtering constraints may place constraints on the applications and/or actions that can be included in the action response 204. In some cases, the filtering constraints may include a blacklist that indicates applications and/or actions that should not be included in the action response 204. In the case of a blacklist, the action system 100 may filter out (e.g., remove) applications and/or actions on the blacklist. In some cases, the filtering constraints may include a whitelist that indicates applications and/or actions that should be included in the action response 204. In the case of a whitelist, the action system 100 may filter out applications and/or actions that are not included on the whitelist. The filtering constraints may allow application developers to control the types of action links (e.g., applications and actions) that are inserted into their applications.

The action request 202 may indicate a number of desired action links to be sent in the action response 204. The action system 100 may limit the number of action links sent in the action response 204 to the number of desired links indicated in the action request 202. For example, the action system 100 may send the highest scoring action links up to the indicated number. In some cases, the number of desired action links may not be indicated. In these cases, the action system 100 may determine the number of action links to send to the requesting device (e.g., a default number). In some cases, the requesting device may be configured to select which action links are rendered.

The action request 202 can include requesting device metadata. Example device metadata may include, but is not limited to, device model, device operating system, and cell carrier identification data. The device metadata may be used to select action links that are compatible with the requesting device (e.g., compatible with the operating system). Also, the device metadata may be used for scoring the action links, as users with different types of devices, operating systems, and carriers may have different preferences for applications and actions.

The action response 204 may include one or more action links. The action links (e.g., URLs) can route a user device to an application state if the application associated with the application state is installed on the user device. In some examples, the action link may route the user device to a corresponding webpage or the digital distribution platform site for downloading the application if the application is not installed on the user device. In some implementations, the action link may include a URL. In other cases, the action link can include one or more data fields, such as app-specific IDs, that the specific application can use to access the application state. For a single entity, there can be a set of action links in the action response 204, where each action link is associated with an application and an action for the application. In some cases, an action response may include multiple action links for the same application and different actions. In some cases, an action response 204 can include different action links for the same action, but for different applications. In some cases, the action links may specify other types of resources, such as remote device references that instruct a television to open an application to a specific state.

The action response 204 may include display data for rendering the action link(s). The display data may include text and/or images for rendering an action link. Example text may include a title, short description, an action, the name of the associated application, and/or a rating. Example images may include an application logo in some cases. In some cases, an image may indicate the action associated with the rendered action link (e.g. a car image for a delivery action). In one example, an action link for requesting a reservation at a specific restaurant may include a logo for the application and/or text that indicates the user can “reserve a table” at the specific restaurant. In some implementations, the action response may include metadata for the entity associated with the action link. Such metadata may be similar to the types of metadata included in the action request. For example, for a non-POI music entity, the action response may include an album name and a song name.

FIGS. 6A-6B illustrate example entity records 320-1, 320-2. FIG. 6A illustrates an example app-specific entity record 320-1. FIG. 6B illustrates an example global entity record 320-2. The entity identification module 300 can identify one or more app-specific entity records 320-1 and/or global entity records 320-2 by matching entity identification data in the action request (e.g., entity IDs, text, and/or numbers) to the data included in the entity records.

Referring to FIG. 6A, the app-specific entity record 320-1 includes an app-specific entity ID/Name 600 (hereinafter “app-specific entity ID 600”). The app-specific entity ID 600 may include text, numbers, and/or symbols that identity an entity (e.g., uniquely identify an entity) in an application. In some cases, the app-specific entity ID 600 may include a human readable entity name or partial entity name. In some cases, the app-specific entity ID 600 can be an ID that is assigned by the application developer and used within the application and/or on a corresponding website.

An application may include application states for a plurality of different entities. Accordingly, there may be multiple app-specific entity records associated with a single application. Each of the app-specific entity records can have a different app-specific entity ID that uniquely identifies the record. For example, a restaurant reservation application can have different app-specific entity records and IDs for different restaurants. In another example, a movie review application can have different app-specific entity records and IDs for different movies, actors, and directors.

The app-specific entity record 320-1 includes entity information fields 602 that can include data related to the entity. For example, the app-specific entity information 602 can include an entity type field 604. The entity type field 604 may indicate one or more types associated with the entity. For example, the entity type may be a category associated with the entity. Example entity types may include, but are not limited to, a point of interest, a business, a restaurant, a movie, and a public figure. The other fields of app-specific entity information 602 may vary based on the “entity type.” For example, the fields of app-specific entity information may be “type-appropriate metadata” for the entity.

Entity information 602 may include additional fields of data (e.g., at 610) that are descriptive of the entity. For example, the entity information may include data fields for name(s), postal address(es) (e.g., at 606), geolocation (e.g., at 608), dates (e.g., birth dates), hours of operation, phone numbers, or any other description/information provided by the application state associated with the entity. In the specific example of FIG. 6A, the app-specific entity record may be for a point of interest that includes a postal address 606 and a geolocation 608. In another example, if the entity is a restaurant, the entity may have a restaurant entity type and additional information indicating the address of the restaurant, hours of operation, a phone number, and a menu. In another example, if the entity is a song, the entity may have a song entity type and include additional information indicating the song's release date, song length, one or more artist(s), and an album name.

FIG. 6B illustrates an example global entity record 320-2. The global entity record 320-2 includes a global entity ID/Name 612 (hereinafter “global entity ID 612”). The global entity ID 612 may include text, numbers, and/or symbols that identity an entity (e.g., uniquely identify an entity) across a plurality of app-specific entity records. For example, the global entity ID 612 may be used to identify a group of app-specific entities across a plurality of different applications. In some cases, the global entity ID 612 may include a human readable entity name or partial entity name. In some cases, the global entity ID 612 can be an ID that is generated and assigned by the owner/operator of the action system 100 as a way to group the same (or similar) app-specific entities under a common global entity ID 612.

The global entity record 320-2 includes a set of app-specific entity IDs 614. The app-specific entity IDs 614 can point to app-specific entity records 616 associated with the same entity in different applications. For example, a global entity record 320-2 for a restaurant may include app-specific IDs that point to different instances of the restaurant in a restaurant reservation application, a review application, a delivery application, and a health/nutrition application. As another example, a global entity record for a movie may include app-specific entity IDs that point to different instances of the movie in a streaming application, a movie review application, and a movie ticket purchasing application.

The global entity record 320-2 includes global entity information fields 618 that can include data related to the entity. For example, the global entity information 618 can include an entity type field 620. The entity type field 620 may indicate one or more types associated with the entity. Global entity information 618 may include additional fields of data 622 that are descriptive of the entity. For example, the global entity information 618 may include similar data fields as described with respect to the app-specific entity information fields 602. In some implementations, the global entity information field 618 may include entity information from the different referenced app-specific entity records 616. For example, the global entity information 618 may be a merging of the app-specific entity records 616.

In some implementations, the action system 100 can include modules (not illustrated) that acquire data for the entity records 320 and generate the entity records 320 based on the acquired data. For example, the action system 100 may acquire data for entity records 320 from web/application crawling. As another example, the action system 100 may acquire data from application servers (e.g., via API calls to the application servers). In some implementations, action system partners or other third parties can provide data to the action system 100 for generating the entity records 320. The action system 100 can generate the global entity records 320-2 by merging multiple app-specific entity records 320-1 that are associated with one another (e.g., via similar terms and other data, such as names and addresses). In some cases, merging can enhance the global entity record by combining partial information across a variety of app-specific entity records. For example, a restaurant review application for an entity might include cuisines, while the delivery application for the entity may not. In this example, merging may allow for the data from multiple applications to be combined to maximize the ability to find the desired entity.

FIGS. 7A-7B illustrate example action records 322-1, 322-2 that may be used by the action identification module 304 to identify action links based on identified entity IDs. FIGS. 7A-7B illustrate two different types of action records 322. FIG. 7A includes a set of action links 704 and associated action link metadata (e.g., application ID/Name and action ID/Name) that can be identified from an app-specific entity ID 700 at action request time. FIG. 7B illustrates an example action record 322-2 that allows the action identification module 304 to dynamically generate action links (e.g., based on data included in the action request and/or entity records). In general, the action identification module 304 can receive one or more entity IDs and/or request metadata, identify an action record, and output a set of action links. In some implementations, the action identification module 304 can generate an action link (e.g., according to a dynamic action record 322-2).

Referring to FIG. 7A, the action record 322-1 includes an app-specific entity ID 700 that identifies the action record 322-1 (e.g., uniquely identifies the action record). The action identification module 304 may identify the action record 322-1 based on an entity ID output by the entity identification module 300. The action identification module 304 may identify multiple action records when multiple app-specific entity IDs are provided to the action identification module 304.

The action record 322-1 includes action link data 704. The action link data 704 includes a plurality of action links 704-1, 704-2, . . . , 704-N. Each of the action links may be associated with an application ID/Name and an action (e.g., an action ID/Name). The action ID/Name may include an identifier (e.g., a number) that identifies the action. Additionally, or alternatively, the action ID/Name may include a human readable name that indicates the action associated with the action link. In some cases, the action record 322-1 may include a single action link for the application (e.g., the application associated with the app-specific entity ID). The single action link can be associated with a single action. In one example, if a business review application provides a single page for a review of a specific business entity, the action record may include a single action link to the page that provides the review of the specific business entity.

In some cases, an action record may include multiple action links for the same application (e.g., the application associated with the app-specific entity ID). The multiple action links can be associated with different actions provided by the application. For example, if a travel application provides reviews of a restaurant (the app-specific entity), reservations for the restaurant, and a menu for the restaurant, the action record may include action links to each of those corresponding application states. The action links may be associated with a review action ID/Name, a reservation action ID/Name, and a menu action ID/Name.

The action record 322-1 may include display data 706 for rendering the action links. For example, the display data 706 may include text and/or images for rendering the action links, as described herein. Different action links may share some display data, such as the application name and application logo. Each action link may also be associated with different display data, such as different display text (e.g., a different action name, title, and description) and a different action logo (e.g., in the case the rendered action link includes a graphical action button).

FIG. 7B illustrates an example action record 322-2 that the action identification module 304 can use to generate an action link at action request time. The action record 322-2 of FIG. 7B may be referred to as a “dynamic action record 322-2.” The action record 322-1 of FIG. 7A may be referred to as a “static action record,” as the action links may be set before receiving the action request, although the action record 322-1 can be updated over time.

The dynamic action record 322-2 includes one or more dynamic link conditions 708. The dynamic link conditions 708 are a set of one or more conditions that, if satisfied, can cause the action identification module 304 to generate an action link and associated action link metadata according to the dynamic action record 322-2. For example, the dynamic action record 322-2 can include dynamic link generation rules 710 that the action identification module 304 can use to generate an action link. The dynamic link generation rules 710 can include an action link template (e.g., a URL template) that the action identification module 304 can populate with values (e.g., from the action request) to generate an action link. The generated action links can be scored/filtered by the action scoring module 308 in a similar manner as the static action links.

The dynamic action record 322-2 can include an application ID/Name 712 and an action ID/Name 714 to apply to a generated action link. The dynamic action record 322-2 can also include display data 716 for the generated action link. In some implementations, the action identification module 304 can dynamically generate display data for the action link, such as display text.

The dynamic link conditions 708 may be satisfied by values included in the action request and/or data included in the identified entity records. In one example, a dynamic link condition may be satisfied by an app-specific entity ID. For example, an app-specific entity ID in the action request and/or an identified app-specific entity record may trigger the generation of an action link and associated action link metadata.

In another example, a dynamic link condition may be satisfied when an identified app-specific entity record includes a specific entity type. For example, if an identified app-specific entity record is a point of interest type, the action identification module 304 may automatically generate action links for various mapping applications. In a specific example, the action identification module 304 may generate an action link for a mapping application by inserting a postal address and/or geolocation into a mapping URL template for the mapping application.

In another example, a dynamic link condition can be satisfied when additional data in an app-specific entity record is a specific type of data. For example, the action identification module 304 may generate a call action link for making a phone call if a phone number is identified in the entity information. As another example, the action identification module 304 may generate a mapping action link if an address is present in the entity information.

In another example, a dynamic link condition may be satisfied when a search query is included in the request metadata. For example, the action identification module 304 may generate a search action link for one or more search applications if a search query is present in the request metadata. In this example, the action links may launch one or more search applications that search for the included search query. As another example, a dynamic link condition may be satisfied by the presence of some terms in the search query. For example, the inclusion of a location in the search query may trigger the action identification module 304 to generate a mapping action link to the location.

In some cases, the entity identification module 300 may not identify an entity record based on the received entity identification data. In these cases, the action identification module 304 can be configured to generate one or more default action links. For example, the action identification module 304 may be configured to generate default action links according to one or more default dynamic action records 322 that may be triggered when no entity record is identified by the entity identification module 304. For example, the action identification module 304 may generate an action link according to data included in the action request. In one specific example, the action identification module 304 may generate an action link for searching in an application (e.g., an encyclopedia application or mapping application) based on a user entered search query or other data.

The action records 322 can be generated in a variety of ways. In some implementations, an action ontology may be stored by the action system 100 in the form of a list of actions that correspond to applications and/or application states. The action system 100 can use the action ontology to assign actions to the different applications and application states. For example, the action system 100 may include one or more modules (not shown) that can assign actions to action links. The action ontology may be defined by the action system administrator. In some examples, the action system administrator can create an action ontology specific to the action system 100. In other examples, the action system administrator may select actions from an existing ontology, such as one provided by schema.org.

Actions can be assigned at the application level (e.g., one or more actions to each state in the app). In some cases, actions can be assigned to groups of action links for an application. For example, actions can be assigned to action links according to the domain and path associated with the action links. In one example, a business review application can include a first set of action links for business reviews and a second set of action links for driving directions to the businesses. In this example, the first and second sets of action links can be assigned the actions “read review” and “driving directions,” respectively.

The action links may be assigned actions manually and/or automatically. In some implementations, the action system administrator can manually assign the actions to the action links. The action system 100 may then be configured to assign the actions to additional action links (e.g., based on similar action link domains/paths). In some implementations, the action system 100 can automatically acquire the actions based on metadata included in the application/web states. For example, if the application/web states include metadata that indicates the action associated with the application/web states, the action system 100 can assign the action in the metadata to the action links. In some implementations, the action system 100 may assign the actions to the states when crawling (e.g., according to a set of rules).

FIGS. 8A-11B illustrate example features of the entity identification module 300. The entity identification module 300 can identify entities (e.g., app-specific entity records) in a variety of ways using entity identification data received in the action request. For example, the entity identification module 300 can identify entities using received entity IDs and/or request metadata.

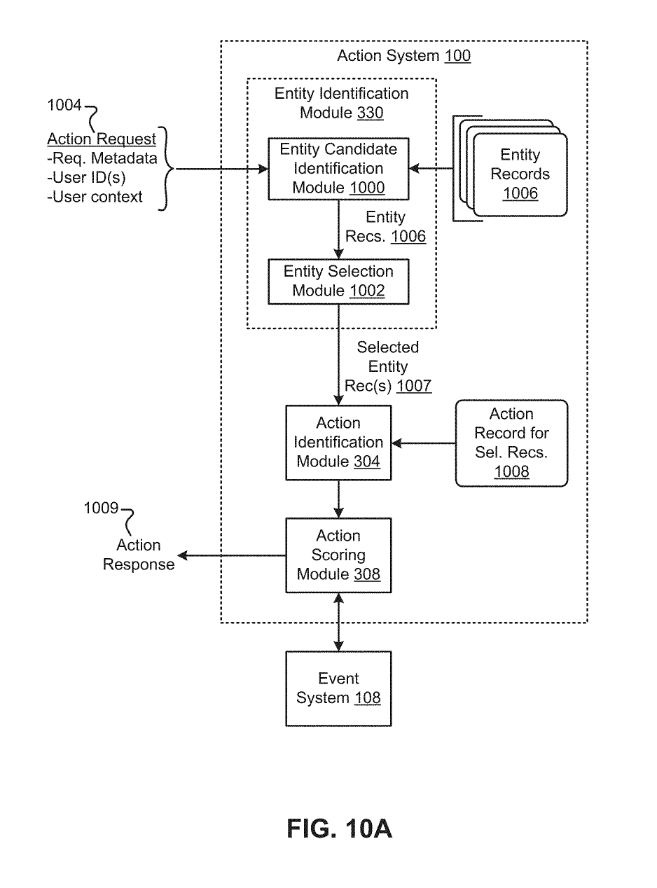

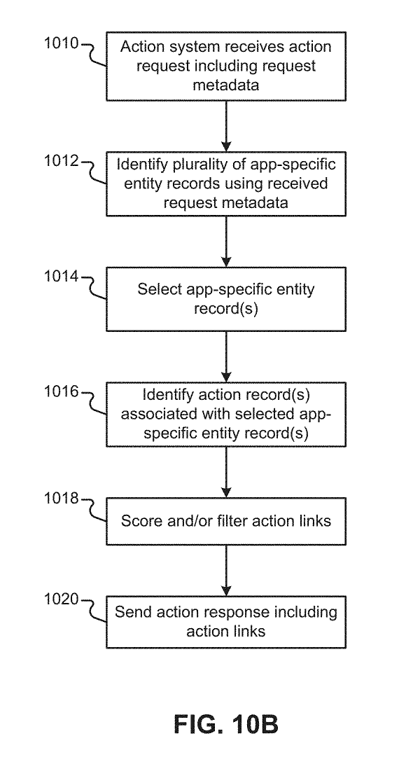

In some examples, the entity identification module 300 can receive app-specific entity IDs in the action request and identify the app-specific entity records directly (e.g., see FIGS. 8A-8B). In some examples, the entity identification module 300 can receive a global entity ID and use the global entity ID to identify a global entity record that includes a plurality of app-specific entity IDs (e.g., see FIGS. 9A-9B). In some examples, the entity identification module 300 can receive app-specific entity IDs and identify one or more associated global entity IDs. The entity identification module 300 can then identify the app-specific entity IDs pointed to by the global entity records. In some examples, the entity identification module 300 can receive request metadata and identify one or more app-specific entity IDs and/or global entity IDs based on the received request metadata (e.g., see FIGS. 10A-10B).

In some examples, the entity identification module 300 can identify an initial set of entity IDs based on the received entity identification data and then identify additional entities based on the originally identified entities. For example, the entity identification module 300 can identify the additional entities based on the entity information associated with the initial set of entities. In a more specific example, if the entity identification module 300 receives an app-specific entity ID in the action request, the entity identification module 300 can first identify the app-specific entity record associated with the received app-specific entity ID. Then, the entity identification module 300 can identify additional entity IDs (e.g., app-specific and/or global IDs) using the entity information of the initially identified app-specific entity record. The entity identification module 300 may use the entity information to identify the additional entities in a similar manner that the entity identification module 300 uses request metadata to identify entity records (e.g., via text matches).

FIGS. 8A-8B describe identification of a single app-specific entity record based on a received app-specific entity ID. In this example, a single action link is included in an action response. The scenario of FIG. 8A is meant to illustrate how a single app-specific entity record can be identified and a single action link can be generated. Although a single action link is illustrated, additional action links for additional results may be generated in the manners described herein.

FIG. 8A illustrates an example user device 102 that accessed a search page of a search application. In this example, the user device 102 is illustrated as sending the action request 800 to the action system 100, although the action request 800 for the search page may be sent in other manners, such as by a remote search server calling the action system 100 (e.g., FIG. 1) or a search system operated by the same party as the action system (e.g., FIG. 2B).

In FIG. 8A, the user entered a search query of “Pizza.” The search system (not illustrated) performed a search based on the search query. The search results include PIZZA HUT®-728 Geary St in the Review App, PIZZA HUT®-3349 Mission St in the Review App, the DOMINOS PIZZA® native application, and a link to the Recipe App for making great pizza. The action request 800 includes an app-specific entity ID along with other data, such as a user ID and user context.

In the example of FIG. 8A, it can be assumed that the action request 800 is for a single action link for the first search result. As such, the action request 800 includes the app-specific entity ID for the PIZZA HUT® store at 728 Geary St in the Review App. The entity identification module 300 identifies the app-specific entity record 802 associated with the app-specific entity ID. The app-specific entity record 802 includes an entity type “Restaurant,” an address for the PIZZA HUT® restaurant, and a menu.

The action identification module 304 identifies the action record 804 associated with the single identified app-specific entity ID. The action record 804 includes a plurality of action links and associated metadata. Specifically, the action record 804 includes action links for a delivery action, a review action, and a menu action. The action record 804 also indicates the application ID/Name of the associated application as “Delivery App,” which may be an application that provides delivery actions along with some other actions (e.g., review and menu actions). The action record 804 also includes display data for the action links. The action scoring module 308 scores the action links in the action record 804 and selects the highest scoring action link (i.e., Action Link 1) for inclusion into an action response 806 sent to the user device 102. As illustrated in FIG. 8A, the user device 102 has rendered the received action link 808 for delivery in the first search result 220-1 (i.e., the PIZZA HUT® restaurant at 728 Geary St.).

Although FIG. 8A illustrates an example search application receiving an action link, other applications may make action requests in a similar manner. For example, an application may make an action request for additional action links within itself in order to leverage the ranking and personalization features of the action system 100. Alternatively, the owner/developer of the application may implement the action system functionality on its own servers.

FIG. 8B illustrates a method describing example operation of the entity identification module 300 for a received app-specific entity ID. In block 810, the action system 100 receives an action request 800 including an app-specific entity ID. In block 812, the entity identification module 300 identifies the entity record 802 associated with the received app-specific entity ID. In block 814, the action identification module 304 identifies an action record 804 associated with the received app-specific entity ID. The identified action record 804 includes a plurality of action links. In block 816, the action scoring module 308 scores and/or filters the action links. In block 818, the action system 100 sends an action response 806 to the requesting device 102. The action response can include one or more of the scored action links (e.g., a single action link in FIG. 8B).

FIGS. 9A-9B illustrate identification of multiple app-specific entity records based on a received global entity ID. In FIG. 9A, the action request 900 includes a global entity ID along with additional request data, such as one or more user IDs and user context. The action request 900 may include a global entity ID in implementations where the requesting device has knowledge of the global IDs included in the entity data store 302. For example, if the application making the action request is owned/operated by the same party that owns/operates the action system 100, the requesting device (e.g., application) can directly send a global entity ID to the action system 100. In another example, the action system administrator can provide global IDs to partners that can then include the global IDs into their partner applications for making requests to the action system 100.

In the example of FIG. 9A, the entity identification module 300 identifies a global entity record 902 that corresponds to the received global entity ID. The entity identification module 300 can then identify a plurality of app-specific entity records 904 that are pointed to by the global entity record 902. The plurality of app-specific entity records 904 can be associated with a plurality of different applications. Each of the app-specific entity records 904 may also be associated with one or more action links. As such, using a global entity ID to identify a plurality of app-specific entity records may enlarge the pool of possible action links that can be sent to the requesting device.

The action identification module 304 can identify action records 906 corresponding to the app-specific entity IDs. The action identification module 304 can identify one or more action links for each of the action records 906. The action scoring module 308 scores/filters the identified action links and sends the action links to the requesting device in an action response 908.

FIG. 9B illustrates a method describing example operation of the entity identification module 300 for a received global entity ID. In block 910, the action system 100 receives an action request 900 that includes a global entity ID. In block 912, the entity identification module 300 identifies a global entity record corresponding to the received global entity ID. In block 914, the entity identification module 300 identifies a plurality of app-specific entity records pointed to by the global entity record. In block 916, the action identification module 304 identifies action records 906 corresponding to the plurality of app-specific entity records 904. In block 918, the action scoring module 308 scores and/or filters the action links from the identified action records 906. In block 920, the action system 100 sends an action response to the requesting device including the action links.

In some implementations, instead of directly receiving a global entity ID in an action request, the entity identification module 300 can identify a global entity ID based on a received app-specific entity ID. For example, the entity identification module 300 can identify a global entity record that includes the received app-specific entity ID. In these implementations, the entity identification module 300 can then identify the additional app-specific entity records pointed to by the identified global entity record, as described with respect to FIGS. 9A-9B.

FIGS. 10A-10B describe the identification and selection of entity records based on received request metadata. The entity identification module 300 includes an entity candidate identification module 1000 (hereinafter “candidate identification module 1000”) and an entity selection module 1002 that perform the identification and selection operations, respectively.

In FIGS. 10A-10B, the candidate identification module 1000 receives an action request 1004 that includes request metadata. The candidate identification module 1000 identifies a plurality of candidate app-specific entity records 1006. The candidate identification module 1006 can identify entity records based on matches between the request metadata (e.g., a search query) and data included in the app-specific entity records, such as entity names, addresses, text in the description, and geolocation relative to the user's geo. In some cases, the request metadata may include data from one or more search results from a search engine result page. Different types of search results may yield different types of request metadata. Example metadata may include a result title, entity name, entity postal address, a URL, and a description. In some cases, the request metadata may include the search query in addition to the request metadata for the search results. In one specific example, a search result for a search query “Pizza” may yield a specific pizza restaurant name at a specific postal address. In some cases, the search query “Pizza” may be included as part of the request metadata.

The candidate entity records 1006 may be associated with a plurality of different entities. For example, the candidate entity records 1006 can be associated with different businesses (e.g., different restaurants or stores) in the same application or different applications. The entity selection module 1002 can select one or more of the candidate entity records. For example, the entity selection module 1002 can select one or more candidate entity records that are associated with the same entity (e.g., the same restaurant or store). The entity selection module 1002 can select the one or more candidate entity records based on how well the entity record matched the request metadata. The entity selection module 1002 may implement matching conditions to determine whether an entity record matches the request metadata. In some implementations, the entity selection module 1002 may generate a score that indicates how well the entity record matches the request metadata. In these implementations, the entity selection module 1002 may determine that an entity record matches the request metadata if the score is greater than a threshold value. In some implementations, the entity selection module 1002 may implement other conditions for identifying a match, such as a naming condition (e.g., where a name matches if there is at most one edit distance) and/or a distance condition (e.g., a geolocation is within a specified distance).

FIG. 10B illustrates a method describing example operation of the entity identification module 300 for received request metadata. In block 1010, the action system 100 receives an action request 1004 that includes request metadata. In block 1012, the candidate identification module 1000 identifies a plurality of app-specific entity records 1006 based on the received request metadata. In block 1014, the entity selection module 1002 selects one or more of the candidate app-specific entity records 1006. In block 1016, the action identification module 304 identifies action records 1008 associated with the selected app-specific entity record(s) 1007. In block 1018, the action scoring module 308 scores and/or filters action links from the identified action records 1008. In block 1020, the action system 100 sends the action response 1009 including the action links to the requesting device.

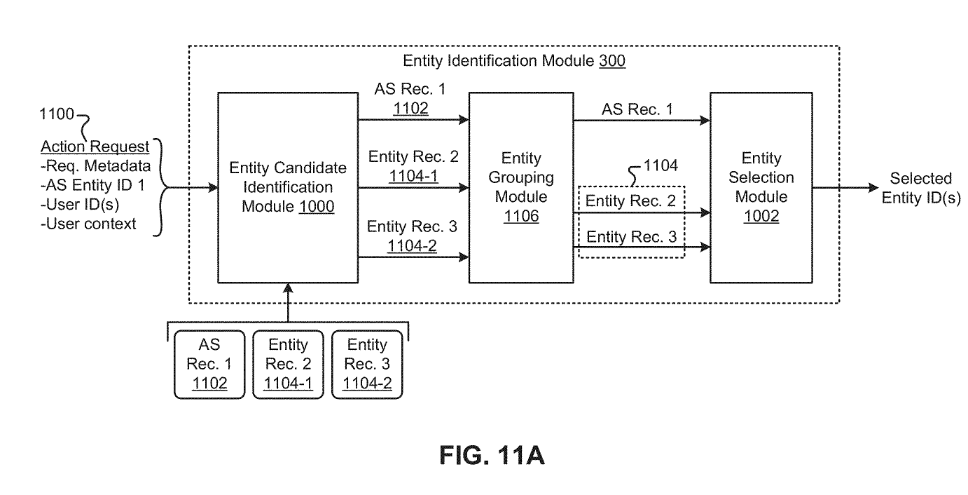

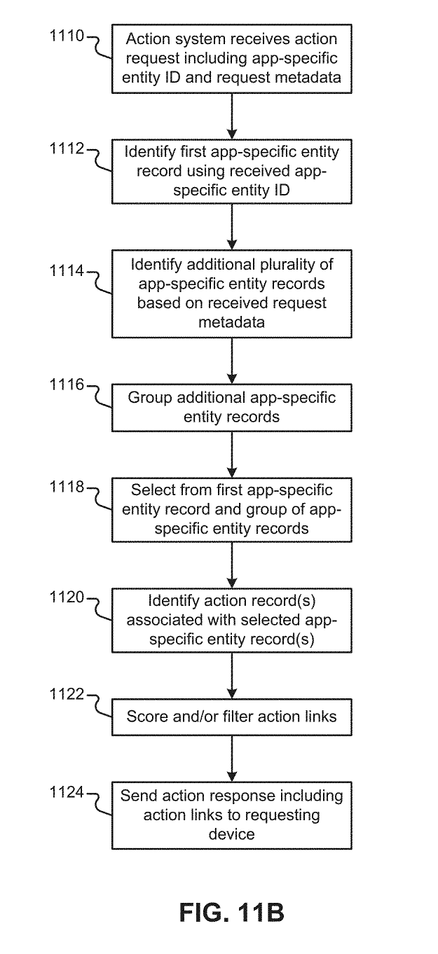

FIGS. 11A-11B illustrate identification of multiple candidate entity records, grouping of some entity records (e.g., grouping records for a single entity), and subsequent entity selection. In FIG. 11A, the entity identification module 300 receives an action request 1100 that includes an app-specific entity ID (“AS Entity ID 1”) and request metadata. The candidate identification module 1000 identifies an app-specific entity record 1102 based on the received app-specific entity ID AS Entity ID 1. The candidate identification module 1000 also identifies two app-specific entity records 1104-1, 1104-2 based on the request metadata.

The entity identification module of FIG. 11A includes an entity grouping module 1106. The entity grouping module may group entity records together when the entity records are associated with the same entity. For example, if two identified app-specific entity records are directed to the same entity (e.g., a restaurant), but not grouped under a global entity ID, the entity grouping module 1106 may group the two app-specific entity records together at action request time. Grouping entity records at action request time may yield more potential action links for user selection.

The entity grouping module 1106 can group entity records based on matches between data (e.g., terms or other data, such as names and addresses) associated with the app-specific entity records that indicates a likelihood that the entities are the same. For example, the entity grouping module 1106 may group app-specific entity records together based on matching addresses in the different entity records. In some implementations, the entity grouping module 1106 can group entities together according to similar criteria as described herein for entity merging.

In FIG. 11A, the entity grouping module 1106 groups entity record 2 1104-1 and entity record 3 1104-2 together. The grouped entity records may then be treated as a single entity record (e.g., as a global entity record). The entity selection module 1002 may then select the grouped entity records as a single entityl 104. For example, the entity selection module 1002 may select either the app-specific entity record 1 1102 or the grouped entity records 1104 for further processing. The selected entity record(s) may then yield one or more action links that can be scored/filtered as described herein.

FIG. 11B illustrates a method describing example operation of the entity identification module 300 in FIG. 11A. In block 1110, the action system 100 receives an action request 1100 including an app-specific entity ID and request metadata. In block 1112, the candidate identification module 1000 identifies a first app-specific entity record 1102 using the received app-specific entity ID. In block 1114, the candidate identification module 1000 identifies a plurality of additional app-specific entity records 1104-1, 1104-2 based on the request metadata.

In block 1116, the entity grouping module 1106 groups the additional app-specific entity records 1104-1, 1104-2 together. In block 1118, the entity selection module 1002 selects either the first app-specific entity record or the group of additional app-specific entity records. In block 1120, the action identification module 304 identifies one or more action records associated with the selected entity record(s). In block 1122, the action scoring module 308 scores/filters the action links from the identified action record(s). In block 1124, the action system 100 sends an action response including action links to the requesting device.

FIG. 12 illustrates an example action system 100 that generates action links based on static action records 1200 and dynamic action records 1202. In FIG. 12, the action identification module 304 includes a condition detection module 1204 and an action link generation module 1206. The condition detection module 1204 determines whether dynamic link conditions are satisfied for any dynamic action records 1202. The action link generation module 1206 generates action links for the identified dynamic action records 1202 based on the dynamic link generation rules 710. The action identification module 304 can also include action links from identified static action records 1200. The action scoring module 308 can score the dynamic action links along with the static action links.

The search engine result page of FIG. 12 includes the same search results 220 as FIG. 2B. The search engine result page also includes similar static action links 1208-1, 1208-2 for delivery as in FIG. 2B. Additionally, the search engine result page includes two dynamic actions 1210-1, 1210-2 for the first search result 220-1. Specifically, the first search result 220-1 includes a corresponding maps action link 1210-1 and a call action link 1210-2. The action identification module 304 may have generated the maps action link 1210-1 based on an address included in an app-specific entity record for the PIZZA HUT® at 728 Geary St. in the Review App. The action identification module 304 may have generated the call action link 1210-2 based on a telephone number included in an app-specific entity record for PIZZA HUT® at 728 Geary St. in the Review App and a device operating system from the action request.

The event system 108 may include a user data store 310, an aggregate data store 312, an additional data store 314, and a data processing module 316. The data processing module 316 may acquire some of the data included in the data stores 310, 312, 314. For example, the data processing module 316 may acquire the user data and the additional data. The data processing module 316 may also generate some of the data based on other data included in the data stores 310, 312, 314. For example, the data processing module 316 can generate derived user values based on user data. As another example, the data processing module 316 can generate aggregate data based on data for a plurality of users.

FIGS. 13A-13B illustrate example data structures that may be included in the event system data stores 310, 312, 314. Referring to FIG. 13A, the user data store 310 includes user-specific data records 1300 (hereinafter “user data records 1300”). A user data record 1300 may include data associated with a specific user. The user data record 1300 may include one or more user IDs 1302 associated with the user (e.g., the user's device). For example, the user data record 1302 may include a device ID, web ID, and/or advertising ID associated with the user's device.

The user data record 1300 includes a list of user events 1304. The list of user events 1304 can detail a user's engagement within different applications and websites. Events associated with accessing webpages on a web browser may be referred to as “web events.” Events associated with other applications installed on the user device can be referred to as “application events.” An example application event may include a user accessing an application state associated with an action. Other example application events may include a user opening or installing an application that is associated with one or more actions (e.g., opening a restaurant page that provides delivery). Additional example application event types may include, but are not limited to, closing an application, reinstalling an application, purchasing an item in the application, and sharing an action link with another user. Example web events may include accessing a webpage associated with an action, purchasing an item from a website, and sharing an action link with another user.

A single user event (e.g., application event or web event) can include a variety of different types of data. For example, a single user event can include an event identifier that indicates the type of event. A single user event may also indicate the application state or website visited (e.g., the deep link or URL for accessing the state/page), the application associated with the event (e.g., an application ID), and the action associated with the event (e.g., an action ID). A user event may also include additional context data, such as a timestamp indicating when the event occurred (e.g., time of day and/or day of week) and a geolocation/locale in which the user was located when the event occurred. A user event can also include device metadata, such as the device operating system and device type (e.g., mobile/desktop/television). The data associated with each event may vary, depending on the data provided to the event system 108. For example, each event may not always include the data above (e.g., application ID, action ID, and/or deep link). In a specific example, a user event may include a deep link, a timestamp, an application ID, and an action ID, but not include an event type indicator.

The event system 108 can store any number of user events in a user data record 1300. For example, the event system 108 may be configured to store the last N events (e.g., the last 100 events) for the user device. In another example, the event system 108 may be configured to store the events over a period of time (e.g., the last N days). In another example, the event system 108 may be configured to keep a total count of each type of event over a time window. The user event list 1304 of FIG. 13A illustrates 5 example events among a list of events. The events in the user event list 1304 are associated with different variations of applications and actions. Each event in the event list includes a link (e.g., a URL), a timestamp, an action ID, an application ID, and user geo.

The user data record 1300 can include derived user values 1306 that can be determined based on past user events, such as the user events included in the user data record 1300 and user events that occurred prior to the events in the user data record 1300. In some implementations, the event system 108 (e.g., the data processing module 316) can calculate the derived user values prior to receipt of an action request so that the derived user values are ready to be used for scoring. In other implementations, the event system 108 (e.g., the data processing module 316) can calculate the derived user values at scoring time.

The derived user values can include total count values. The total count values for various aspects of the events may include, but are not limited to, a total count of event types, a total number of times an application was used, a total number of times actions were accessed, and a total number of times app-action pairs were accessed. An app-action pair for an accessed application state may refer to the combination of the application and the action associated with the accessed application state. For example, an app-action pair for an application state in a music application that plays a specific song may be the app-action pair (app: music application, action: play song). App-action pair values may also apply to accessing webpages on a website. For example, an app-action pair for an accessed webpage may refer to the combination of the website and the action associated with the accessed webpage. In some implementations, applications and websites may have corresponding states/pages that can be normalized to a single app-action pair data structure (e.g., the website is mapped to the corresponding application). User values indicating a number of app-action pairs (e.g., total number) and/or relative use of app-action pairs may indicate a user's preference for using a specific application for a specific action. As such, user values associated with app-action pairs may be used to personalize (e.g., score/filter) action links.

The derived user values can also include relative count values that indicate various count values in relation to other values. An example relative count value may include relative application usage values. A relative application usage value may be a value for an application indicating how often it was used relative to other applications (e.g., a usage ratio). In a specific example, a relative application usage value fora specific application may be calculated by dividing the number of times the specific application was used by a total number of times all applications were used. A relative application usage value may indicate a user's preference for different applications. For example, a greater relative application usage value may indicate that the user prefers using the application relative to other applications.

Another example relative count value may be a relative action value. A relative action value may be a value for an action that indicates how often the action was used relative to other actions (e.g., a usage ratio). In a specific example, a relative action value for a specific action may be calculated by dividing the number of times the specific action was used by a total number of times all actions were used. A relative action value may indicate a user's preference for an action. For example, a greater relative action value may indicate that the user prefers using the action relative to other actions. Another example relative count value may include a relative app-action value. A relative app-action value may be a value for an app-action pair that indicates how often the user uses the app-action pair relative to other app-action pairs (e.g., a usage ratio). In a specific example, a relative app-action value for a specific app-action pair may be calculated by dividing the number of times the specific app-action pair was used by a total number of times all app-action pairs were used. A relative app-action value may indicate a user's preference for the combination of some app-action pairs. For example, an app-action value may indicate the user's preference for using a specific application for a specific action. In some implementations, the user data record can include a list of actions along with a list of the most popular applications for each of the actions (e.g., a ranked list).

The total count values and relative count values described herein can also be calculated according to other variables, such as time of day, day of the week, and/or user location. For example, the user data record 1300 can include different total/relative count values for different blocks of time during the day (e.g., in the morning, afternoon, night) or days of the week. The user data record 1300 can also include different total/relative count values for different geolocations. For example, the user data record 1300 may include different total/relative application usage values for different geolocations (e.g., different countries, states, cities, etc.). The total/relative count values with respect to time and geolocation can be calculated based on the timestamps and geolocations associated with the user events.

The user data records 1300 may include additional derived data. The additional derived data may include, but is not limited to: 1) a timestamp indicating the most recent usage of an app/website, 2) a timestamp indicating the last time an app/website was accessed on a mobile device, 3) a timestamp indicating the last time an app/website was accessed on a desktop device, 4) activity data that indicates how often and when an app/website was used over a period of time (e.g., which days the app/website was used over a predetermined number of previous days), 5) activity data that indicates how often an app/website was used on a mobile device, 6) activity data that indicates how often an app/website was used on a desktop device, and 7) a timestamp indicating the first time the user used the app/website (e.g., an earliest event in the list of events).

The event system 108 may include an aggregate data store 312 that stores a variety of types of aggregate data 1308. The aggregate data values may indicate how a plurality of users engage with different applications and websites. Example aggregate data values may include, but are not limited to, total aggregate values, relative aggregate values, and aggregate values associated with time and geolocation.

The total aggregate values may include, but are not limited to, total counts of event types across a plurality of user devices, a total number of times an application was used across a plurality of user devices, a total number of times actions were accessed across a plurality of user devices, and a total number of times app-action pairs were accessed across a plurality of user devices. The total aggregate values may indicate preferences for users across a plurality of devices. For example, the total aggregate values may indicate applications, actions, and app-actions pairs that are preferred by a plurality of users.

The aggregate data store 312 can include relative aggregate values that indicate various aggregate values in relation to other values. Relative aggregate values may indicate preferences for a plurality of users. Relative aggregate values may include a relative aggregate application usage value that indicates how often an application was used relative to other applications across the aggregate. In a specific example, a relative aggregate application usage value for a specific application may be calculated by dividing the number of times the specific application was used across a plurality of devices by a total number of times all applications were used across the plurality of devices. The relative aggregate application usage value may indicate the aggregate preference, where a greater relative aggregate application usage value may indicate that users tend to prefer the application relative to other applications.

Another example relative aggregate value may be a relative aggregate action value. The relative aggregate action value may be a value for each action that indicates how often the action was used relative to other actions (e.g., a usage ratio). In a specific example, a relative aggregate action value for a specific action may be calculated by dividing the number of times the specific action was used across a plurality of devices by a total number of times all actions were used across the plurality of devices. The relative aggregate action value may indicate preferences for actions across a plurality of users (e.g., a greater value indicates a greater preference).

Another example relative aggregate value may be a relative aggregate app-action value. The relative aggregate app-action value may be a value for an app-action pair that indicates how often the aggregate uses the app-action pair relative to other app-action pairs. In a specific example, a relative aggregate app-action value for a specific app-action pair may be calculated by dividing the number of times the specific app-action pair was used across a plurality of devices by a total number of times all app-action pairs were used across the plurality of devices. The relative aggregate app-action value may indicate the aggregate's preference for the combination of some app-action pairs (e.g., their preference for using a specific application for a specific action). In some implementations, the aggregate data store 312 can include a list of actions along with a list of the most popular applications for each of the actions (e.g., a ranked list).

The total aggregate values and relative aggregate values described herein can also be calculated according to other variables, such as time of day, day of the week, and/or user location. For example, the aggregate data store 312 can include different total/relative aggregate values for different blocks of time during the day (e.g., in the morning, afternoon, night) or days of the week. The aggregate data store 312 can also include different total/relative aggregate values for different geolocations. For example, the aggregate data store 312 may include different total/relative application usage values for different geolocations (e.g., different countries, states, cities, etc.). The total/relative aggregate values with respect to time and geolocation can be calculated based on the timestamps and geolocations associated with the user events.

The total/relative aggregate data can be beneficial for scoring/filtering action links. For example, total/relative aggregate values can provide additional data points (e.g., scoring features) for a user that lacks user-specific data for the usage of certain applications and/or actions. In a specific example, for a newly installed application or unused actions within an application, aggregate data values may be used in place of user-specific values for scoring/filtering action links.

The event system 108 may also include additional data that may be used for scoring the action links. The additional data may be stored in the additional data store 314. Example additional data may include application popularity. For example, application popularity may include a number of times the application was downloaded from one or more digital distribution platforms 122. Additional data may also include user ratings for an application indicating users' overall satisfaction with the application. Additional data may also include a number of active users for an application, such as a number of daily and/or monthly active users (e.g., as indicated by the developer).

FIGS. 14-15B illustrate aspects of the action scoring module 308. FIG. 14 illustrates an example action scoring module 308 that scores and/or filters identified action links based on a variety of input data. Four action links and associated action link metadata (e.g., application ID, Action ID) are illustrated in FIG. 14. Example input data for scoring the action links may include, but is not limited to: 1) the action link metadata associated with the action links (e.g., application IDs and action IDs), 2) entity information that may be retrieved based on the entity IDs associated with the action links, 3) action request data received from the requesting device, 4) user-specific data, 5) aggregate user data, and 6) additional data.

The action scoring module 308 can score the action links based on any of the input data described herein. In some implementations, the action scoring module 308 may implement a scoring function that scores the action links (e.g., see FIG. 15A). In these implementations, the action scoring module 308 may generate scoring features (e.g., numerical values) based on the scoring input data. The scoring features can be input into the scoring function (e.g., a weighted scoring function) where each feature can contribute to an output value, which may be referred to as an action link score. The action link score may be a number (e.g., a normalized output value of 0.000-1.000) that indicates the relevance of the action link (e.g., relevance to the user). Each scoring feature can be weighted in the scoring function to emphasize its overall importance to the action link score.

In some implementations, the action scoring module 308 may implement one or more heuristic models that score/filter the action links. For example, a heuristic model may include rules associated with generating various scoring features. As another example, the action scoring module 308 may include sets of rules for selecting and removing action links without scoring the action links (e.g., using filtering criteria). In some implementations, heuristics may define which actions are selected for sets of conditions (e.g., as indicated by the features or other data). In some cases, heuristics may include a set of rules in order (e.g., reverse of expected accuracy) indicating which actions should be selected.

In some implementations, the features may be used as part of a machine learned scoring model (e.g., based on actual user behaviors and features). In some implementations, a machine learned model may be updated each time the user engages (or receives results and does not engage) with an action. A machine learned scoring model can be trained based on any of the scoring features described herein along with training data. Features may be Boolean or numerical. Some numerical features may be quantized or bucketized.

Examples of machine learned models may include a Bayesian model, a logistic regression, a Neural Network, and/or a Gradient Boosted Decision Tree. In some implementations, the machine learned model(s) may be tuned to give a normalized score, such as a probability (e.g., a probability the user will click an action given the input features). In some implementations, different machine learned models may be used for different actions. For example, there may be a separate machine learned model for each action that can return a probability (or a score), which can be further processed (e.g., sorted along with other probabilities).

Model training (e.g., using labeled training data) may be used to build the machine learned models. In some implementations, the training data may be labeled according to user engagement (e.g., a label for an application, action, and/or app-action pair accessed by the user). For example, user engagement data may be taken from a running system (e.g., one which returns all eligible actions or a random sampling of actions) and assigned a 1 to the clicked action and a 0 to unclicked actions. Other training data may be obtained from surveys where users are asked to rank actions.

Example scoring features may be determined based on any of the user specific values described herein with respect to the user data record 1300, such as total/relative usage (e.g., app, action, app-action pair usage values). Additional example scoring features may be based on any of the aggregate values described herein with respect to the aggregate data 1308 (e.g., app, action, app-action pair usage values). Additional scoring features may be based on the additional data in the additional data store 314. In some implementations, scoring features may be based on other parameters, such as user distance from an entity, the current time, and the user's geolocation. Some example scoring features used to score/filter action links are described hereinafter with respect to FIGS. 15A-15B.

In some implementations, the action scoring module 308 may implement a tiered approach to scoring and filtering. For example, the action scoring module 308 may first score/filter by action usage, and then score by app-action usage. As another example, the action scoring module 308 may first score/filter by application usage, and then score/filter by app-action usage.

FIGS. 15A-15B illustrate an example implementation of the action scoring module 308. The action scoring module 308 includes a scoring feature determination module 1500, a score generation module 1502, and a response generation module 1504. The scoring feature determination module 1500 can determine scoring features for each action link. The score generation module 1502 can determine an action link score for each action link based on the generated scoring features. The score generation module 1502 may also filter out action links (e.g., based on the scoring features, determined action link score, or according to other rules). The score generation module 1502 may implement one or more machine learned models and/or heuristic models for scoring and/or filtering the action links.

The response generation module 1504 generates the action response based on the scored action links. For example, the response generation module 1504 can select the action links to include in the action response based on the action link scores. The response generation module 1504 can also retrieve the display data for the action links.

The action scoring module 308 can score/filter an action link based on the installation status of an application associated with the action link. In one example, the score generation module 1502 can filter out action links if the application is not installed on the user device, as determined by application installation data in the event system 108 and/or received in the action request. In another example, the scoring feature determination module 1500 can generate a scoring feature that takes the application installation status into account (e.g., a 0/1 feature for not installed/installed). In this case, the action links can direct the user to the digital distribution platform 122 for downloading the application if the application is not installed. In another example, the action scoring module 308 can default to sending the action link if the application is installed.

The action scoring module 308 can score/filter an action link based on user-specific application usage data. In one example, the scoring feature determination module 1500 can generate one or more scoring features for the action link that indicate an amount of usage for the application. For example, scoring features can be generated for 1) total uses of the application, 2) relative usage of the application, and/or 3) rate of usage, such as total/relative events over a period of time. In another example, the score generation module 1502 can filter out the action link (e.g., refrain from sending the action link) if the application has not been used, or if it is used less than a threshold amount (e.g., less than a total amount or relative amount). In another example, the action scoring module 308 may be configured to send the action link if the application has been used greater than a threshold amount (e.g., a total/relative amount).

The action scoring module 308 can score/filter an action link based on user-specific action usage data. In one example, the scoring feature determination module 1500 can generate one or more scoring features for the action link that indicate an amount of usage for the action. For example, scoring features can be generated for 1) total uses of the action, 2) relative usage of the action, and/or 3) rate of usage, such as total/relative events over a period of time. In another example, the score generation module 1502 can filter out the action link if the action has not been used, or if it is used less than a threshold amount (e.g., less than a total amount or relative amount). In one example, the action scoring module 308 may be configured to send the action link if the action has been used greater than a threshold amount (e.g., a total/relative amount).

The action scoring module 308 can score/filter an action link based on user-specific app-action usage data. In one example, the scoring feature determination module 1500 can generate one or more scoring features for the action link that indicate an amount of usage for the app-action pair. For example, scoring features can be generated for 1) total uses of the app-action pair, 2) relative usage of the app-action pair, and/or 3) rate of usage, such as total/relative app-action usages over a period of time. In another example, the score generation module 1502 can filter out the action link if the app-action pair has not been used, or if it is used less than a threshold amount (e.g., less than a total amount or relative amount). In one example, the action scoring module 308 can be configured to send the action link if the app-action pair has been used greater than a threshold amount (e.g., a total/relative amount) or if the app-action pair is a highest rated app-action pair (e.g., a user's favorite app for the action).

In some implementations, the action scoring module 308 can personalize the action response based on the user's current geolocation as indicated in the action request. For example, the action scoring module 308 can generate scoring features and/or filter action links based on application usage, action usage, and/or app-action usage for a user with respect to geolocation. In a specific example, if the user is located in a specific city, the action scoring module 308 can generate scoring features and/or filter action links based on application usage, action usage, and/or app-action usage of that user in the specific city. In this manner, the scoring/filtering of action links can be tailored to a user's geolocation.

In some cases, the action scoring module 308 can determine the distance between a user and the entity associated with the action link. The action scoring module 308 can then score/filter an action link based on the distance and the associated action. For example, if the entity is a restaurant, the action scoring module 308 can determine a distance between the restaurant and the user based on data included in the entity record (e.g., a geolocation) and the user's location indicated in the action request. In this example, the action scoring module 308 may score/filter action links based on the distance between the restaurant and the user.

In some implementations, different actions can be associated with different distances, such as a threshold distance and/or a distance range. In these implementations, the action scoring module 308 can score/filter action links based on whether the distance between the entity and the user is greater than or less than the threshold range. The action scoring module 308 may also score/filter action links based on whether the distance between the entity and the user is within a distance range or outside of the distance range. In one example, a driving action may be associated with a range of distances that are associated with driving a car (e.g., between 1 mile and 200 miles). In this example, if the user is within 1-200 miles of the entity, the driving action may be scored and/or included in the action response. If the user is closer than 1 mile to the entity or farther than 200 miles from the entity, then the action link may be filtered out. In another example, a walking action may be associated with a distance of less than 1 mile, where action links associated with walking directions are filtered out if the user is farther than 1 mile from the entity.

In some implementations, the action scoring module 308 can personalize the search results based on the time (e.g., time of day or day of week). For example, the action scoring module 308 can generate scoring features and/or filter action links based on application usage, action usage, and/or app-action usage for a user with respect to time. In one example, if the time of day is night time (e.g., after 8 pm), the action scoring module 308 can generate scoring features and/or filter action links based on application usage, action usage, and/or app-action usage of that user in that specific range of time. In a specific example, if the time of day is morning (e.g., before 12 pm), the action scoring module 308 may filter out action links associated with delivery actions if the user does not typically access delivery actions in the morning. In this manner, the scoring/filtering of action links can be tailored to a user's preferences with respect to time of day. In some examples, time of day may be broken down into a block of time, such as morning (5 am-12 pm), afternoon (12 pm-6 pm), and night (6 pm-2 am). Additionally, or alternatively, time of day may be broken down into blocks of days, such as weekdays (Monday-Friday Afternoon) and weekends (Friday night to Sunday night).

In some implementations, the action scoring module 308 can score/filter action links based on the source data included in the action request. As described herein, the source data can indicate the source of the action request, such as the application, partner server, or search server that generated the action request. For example, the action scoring module 308 can filter out action links associated with applications on a blacklist for the source. In another example, the action scoring module 308 can filter out action links for the same application as the source application since the source application may choose how to arrange its own links.

In some implementations, the action scoring module 308 can score/filter the action links based on the entity information of the app-specific entity record associated with the action links. For example, the action scoring module 308 may determine a scoring feature based on how well a search query in the action request matches the entity information of the app-specific entity record. In some implementations, the geolocation region of the user may be used as a feature. For example, the geolocation feature may indicate what application (e.g., rideshare application or driving directions application) the average user in a geolocation (e.g., New York City or Houston) prefers.

The action scoring module 308 may use aggregate data to score and/or filter the action links in a similar manner as the action scoring module 308 uses user-specific data. For example, the action scoring module 308 can use total and/or relative aggregate app usage values, aggregate action usage values, and aggregate app-action usage values to score each of the action links. Accordingly, the action scoring module 308 can generate scoring features based on the different total/relative aggregate values described herein. The action scoring module 308 can also use the user's geolocation and time data with respect to the aggregate values in order to score/filter action links.

In some implementations, the action scoring module 308 can use the aggregate values together with the user-specific values to score/filter the action links. For example, the action scoring module 308 may score an action link based on features that are generated from user-specific data and features that are generated from aggregate data. In some implementations, the action scoring module 308 can use the aggregate values instead of user-specific values, such as when user-specific values are not available. For example, if a user has an application installed for an action link, but has not used the application, the action scoring module 308 can use aggregate usage values to score the action link.

The action scoring module 308 can score/filter action links based on data included in the additional data store 314. For example, the action scoring module 308 can score/filter action links based on the popularity of the application associated with the action link (e.g., a number of application downloads). In a specific example, the action scoring module 308 can filter out action links associated with unpopular applications (e.g., less than a threshold number of downloads). In another example, the action scoring module 308 can score/filter action links based on ratings (e.g., 1-5) for the application associated with the action link. For example, the action scoring module 308 can filter out action links associated with applications that receive less than a threshold rating value. In another example, the action scoring module 308 can score/filter action links based on a number of active users for the application. For example, the action scoring module 308 can filter out applications with less than a threshold number of active users, such as less than a threshold number of daily/monthly active users.

Another example feature for scoring/filtering may include a distance between the user and a high-density area, such as a distance between the user and a downtown area. Such a distance may indicate a local-business density around the user. Another example feature for scoring/filtering may include whether a business entity is open at the current time (e.g., whether a restaurant is open). A business entity may also be associated with a price scoring feature (e.g., average price for a meal in a restaurant). Another example feature for scoring/filtering may include user-demographics, such as a user's age, sex, income, etc.

FIG. 15B illustrates an example method for scoring and/or filtering action links. The method of FIG. 15B is described with reference to the action scoring module 308 of FIG. 15A. In block 1510, the scoring feature determination module 1500 generates scoring features for the action links. In block 1512, the score generation module 1502 scores and/or filters the action links based on the scoring features. In block 1514, the response generation module 1504 generates the action response including one or more of the action links. In some implementations, the response generation module 1504 may include display data for the action links. In some implementations, the response generation module 1504 may include additional data with the action links, such as the corresponding action link scores, application IDs associated with the action links, and/or action IDs associated with the action links. In some cases, the response generation module 1504 may indicate a rank for each of the action links (e.g., based on the action link scores associated with the links). In block 1516, the action scoring module 308 transmits the action response to the requesting device.

FIG. 16A illustrates a user device 102 in communication with a search server 1600 that includes the action system 100. The user device 102 accesses a search page that may be provided by the search server 1600. The user device 102 may access the search page using a dedicated search application 1602, a search function within an application, or via a web browser application. The user entered a search query for “Pizza” and executed the search by pressing the search GUI element 1604. In response to selecting the search GUI element 1604, the user device 102 sent a search request 1606 to the search server 1600. The search request 1606 can include the search query “Pizza” and other data, such as a user's geolocation and a user identifier (ID).

The search server 1600 includes search modules 1608 that perform a search based on the search query and additional search query data. For example, the search modules 1608 may crawl and index information (e.g., application states and/or webpages) in the search data store 1610 for later retrieval. The search data store 1610 may include data associated with application states and/or webpages, such as search indices (e.g., inverted indices) that the search modules 1608 can use to perform the search. In the example of FIG. 16A, it can be assumed that the search modules 1608 retrieve search results for application states that can be opened on applications installed on the user device 102.

The search modules 1608 identify 4 search results 1612-1, 1612-2, 1612-3, 1612-4 for the Pizza search query that are displayed on the user device 102 in FIG. 16A. Although 4 search results 1612 are illustrated, the search modules 1608 may identify additional search results that are not displayed on the user device 102. The user may scroll down the search result page to view the additional results. The search results 1612 of FIG. 16A include 1) a link to the PIZZA HUT® restaurant at 728 Geary St. in the Review App, 2) a link to the PIZZA HUT® restaurant at 3349 Mission St. in the Review App, 3) a link that opens the DOMINOS PIZZA® application, and 4) a link in a Recipe App for making great pizza.

Each of the search results 1612 can include search result links (e.g., URLs) that access the application states. The search server 1600 (e.g., search modules 1608) is also configured to insert action links into one or more of the search results 1612. For example, the search server 1600 may be configured to insert action links into the first search result 1612-1 (e.g., as illustrated in FIG. 16A). As another example, the search server 1600 may be configured to insert action links into the first N results (e.g., the first 10 results). In another example, specific types of search results may be selected for action links, such as points of interest results, restaurant results, business results, etc. Search results that may receive action links are referred to herein as “preliminary search results.” Preliminary search results that are completed with action links may be referred to herein as “completed search results.”

In FIG. 16A, the search modules 1608 select the first search result 1612-1 as a preliminary search result. In this implementation, the request module 112 makes an action request 1614 for action links corresponding to the first search result 1612-1. The action request 1614 may include the search query, user ID(s), and user context. The action request 1614 may also include entity identification data associated with the entity of the preliminary search result 1612-1 (e.g., PIZZA HUT® restaurant at 728 Geary St.). Example entity identification data may include an entity ID for the app-specific entity in the Review App. Additional example entity identification data may include request metadata associated with the entity. For example, in FIG. 16A, the request metadata may include data associated with the PIZZA HUT® restaurant at 728 Geary St., such as an entity name, address, geolocation, and description.

The action system 100 identifies two action links 1616 for insertion into the preliminary search result 1612-1. Specifically, the action system 100 identifies an action link for a pickup action and an action link for a deliver action. The action system 100 provides the action links 1616 to the search modules 1608 in an action response 1618 (e.g., via the request module 112). The search modules 1608 generate a completed search result that includes the preliminary search result 1612-1 and the included action links 1616. The search server 1600 transmits the search results 1620, including the completed search result, to the user device 102. The user device 102 renders the completed search result along with the additional search results.

FIG. 16B illustrates an example method that describes operation of a search server 1600 that includes an action system 100. The method of FIG. 16B is described with reference to the search server 1600 of FIG. 16A. In block 1630, the user device 102 accesses a search application/website and enters a search query. In block 1632, the user device 102 sends a search request 1606 to the search server 1600. In block 1634, the search server 1600 (e.g., search modules 1608) generates search results including one or more preliminary search results.

In block 1636, the request module 112 makes an action request 1614 to the action system 100 for action links to be included in one or more preliminary search results. In block 1638, the action system 100 identifies action links for the one of more preliminary search results. In block 1640, the search server 1600 (e.g., search modules 1608) includes the action links in the search results. In block 1642, the search server 1600 sends the search results 1620 to the user device 102 for rendering.

In some implementations, the search application/website 1602 can provide search results to the user device 102 without action links. In these implementations, the request module 112 on the user device 102 may be configured to generate one or more action requests for the action system 100 and subsequently include the received action links into the search results. The one or more action requests may include entity identification data for one or more of the search results. In some implementations, the request module 112 on the user device 102 can generate a single action request for each search result. In other implementations, the request module 112 on the user device 102 can generate a single action request that includes data associated with a plurality of search results.

The entity records 320, action records 322, user data records 1300, and aggregate data 1308 described herein represent data stored in the entity data store 302, action data store 306, user data store 310, and aggregate data store 312, respectively. The data stores may include a variety of different data structures that are used to implement the data. Accordingly, the entity records 320, action records 322, user data records 1300, and aggregate data 1308 may be implemented using one or more different data structures than explicitly illustrated herein.

Modules and data stores included in the systems (e.g., action system 100 and event system 108) represent features that may be included in the systems of the present disclosure. The modules and data stores described herein may be embodied by electronic hardware, software, firmware, or any combination thereof. Depiction of different features as separate modules and data stores does not necessarily imply whether the modules and data stores are embodied by common or separate electronic hardware or software components. In some implementations, the features associated with the one or more modules and data stores depicted herein may be realized by common electronic hardware and software components. In some implementations, the features associated with the one or more modules and data stores depicted herein may be realized by separate electronic hardware and software components.

The modules and data stores may be embodied by electronic hardware and software components including, but not limited to, one or more processing units, one or more memory components, one or more input/output (I/O) components, and interconnect components. Interconnect components may be configured to provide communication between the one or more processing units, the one or more memory components, and the one or more I/O components. For example, the interconnect components may include one or more buses that are configured to transfer data between electronic components. The interconnect components may also include control circuits (e.g., a memory controller and/or an I/O controller) that are configured to control communication between electronic components.

The one or more processing units may include one or more central processing units (CPUs), graphics processing units (GPUs), digital signal processing units (DSPs), or other processing units. The one or more processing units may be configured to communicate with memory components and I/O components. For example, the one or more processing units may be configured to communicate with memory components and I/O components via the interconnect components.

A memory component (e.g., main memory and/or a storage device) may include any volatile or non-volatile media. For example, memory may include, but is not limited to, electrical media, magnetic media, and/or optical media, such as a random access memory (RAM), read-only memory (ROM), non-volatile RAM (NVRAM), electrically-erasable programmable ROM (EEPROM), Flash memory, hard disk drives (HDD), magnetic tape drives, optical storage technology (e.g., compact disc, digital versatile disc, and/or Blu-ray Disc), or any other memory components.

Memory components may include (e.g., store) data described herein. For example, the memory components may include the data included in the data stores. Memory components may also include instructions that may be executed by one or more processing units. For example, memory may include computer-readable instructions that, when executed by one or more processing units, cause the one or more processing units to perform the various functions attributed to the modules and data stores described herein.

The I/O components may refer to electronic hardware and software that provide communication with a variety of different devices. For example, the I/O components may provide communication between other devices and the one or more processing units and memory components. In some examples, the I/O components may be configured to communicate with a computer network. For example, the I/O components may be configured to exchange data over a computer network using a variety of different physical connections, wireless connections, and protocols. The I/O components may include, but are not limited to, network interface components (e.g., a network interface controller), repeaters, network bridges, network switches, routers, and firewalls. In some examples, the I/O components may include hardware and software that is configured to communicate with various human interface devices, including, but not limited to, display screens, keyboards, pointer devices (e.g., a mouse), touchscreens, speakers, and microphones. In some examples, the I/O components may include hardware and software that is configured to communicate with additional devices, such as external memory (e.g., external HDDs).

In some implementations, the systems may include one or more computing devices that are configured to implement the techniques described herein. Put another way, the features attributed to the modules and data stores described herein may be implemented by one or more computing devices. Each of the one or more computing devices may include any combination of electronic hardware, software, and/or firmware described above. For example, each of the one or more computing devices may include any combination of processing units, memory components, I/O components, and interconnect components described above. The one or more computing devices of the systems may also include various human interface devices, including, but not limited to, display screens, keyboards, pointing devices (e.g., a mouse), touchscreens, speakers, and microphones. The computing devices may also be configured to communicate with additional devices, such as external memory (e.g., external HDDs).

The one or more computing devices of the systems may be configured to communicate with the network 110 of FIG. 1. The one or more computing devices of the systems may also be configured to communicate with one another (e.g., via a computer network). In some examples, the one or more computing devices of the systems may include one or more server computing devices configured to communicate with user devices. The one or more computing devices may reside within a single machine at a single geographic location in some examples. In other examples, the one or more computing devices may reside within multiple machines at a single geographic location. In still other examples, the one or more computing devices of the systems may be distributed across a number of geographic locations.

What is claimed is:

1. A method comprising:
receiving, at a server, a request that includes entity identification data that indicates an entity associated with a first application state, wherein the request includes a user identifier (ID) that identifies a user device;
identifying, at the server, a first action link based on the entity identification data, wherein the first action link is configured to cause the user device to access a second application state associated with the entity, and wherein the first action link is associated with a first action identifier (ID) that indicates functionality of the second application state;
identifying, at the server, a second action link based on the entity identification data, wherein the second action link is configured to cause the user device to access a third application state associated with the entity, and wherein the second action link is associated with a second action ID that indicates functionality of the third application state;
determining, at the server, a first usage value and a second usage value based on the user ID, wherein the first usage value indicates a number of times the user device has accessed application states associated with the first action ID, and wherein the second usage value indicates a number of times the user device has accessed application states associated with the second action ID;
scoring, at the server, the first action link and the second action link based on the first usage value and the second usage value, respectively;
selecting, at the server, one of the first and second action links based on the scores associated with the first and second action links; and
transmitting, from the server, the selected action link.

2. The method of claim 1, wherein the first usage value indicates how often application states with the first action ID were accessed relative to how often a set of additional action IDs were accessed, and wherein the second usage value indicates how often application states with the second action ID were accessed relative to how often the set of additional action IDs were accessed.

3. The method of claim 1, wherein the first usage value indicates a number of times the user device has accessed application states associated with the first action ID using the application that includes the second application state, and wherein the second usage value indicates a number of times the user device has accessed application states associated with the second action ID using the application that includes the third application state.

4. The method of claim 1, wherein the second application state is included in a first application, wherein the third application state is included in a second application, wherein the first usage value indicates a number of times the user device has accessed application states associated with the first action ID using the first application relative to a number of times the user device accessed other additional action IDs using other additional applications, and wherein the second usage value indicates a number of times the user device has accessed application states associated with the second action ID using the second application relative to a number of times the user device accessed the other additional action IDs using the other additional applications.

5. The method of claim 1, wherein the request includes geolocation data that indicates a current geolocation of the user device, and wherein the method further comprises:
determining, at the server, the first usage value based on the user ID and the current geolocation, wherein the first usage value indicates a number of times the user device has accessed application states associated with the first action ID when the user was located in the current geolocation; and
determining, at the server, the second usage value based on the user ID and the current geolocation, wherein the second usage value indicates a number of times the user device has accessed application states associated with the second action ID when the user was located in the current geolocation.

6. The method of claim 1, wherein the request includes geolocation data that indicates a current geolocation of the user device, and wherein the method further comprises:
determining, at the server, the distance between the user device and the entity based on the current geolocation;
scoring, at the server, the first action link based on the first usage value and the determined distance; and
scoring, at the server, the second action link based on the second usage value and the determined distance.

7. The method of claim 1, further comprising:
determining, at the server, the first usage value based on the user ID and the current time of day, wherein the first usage value indicates a number of times the user device has accessed application states associated with the first action ID during the current time of day; and
determining, at the server, the second usage value based on the user ID and the current time of day, wherein the second usage value indicates a number of times the user device has accessed application states associated with the second action ID during the current time of day.

8. The method of claim 1, wherein the second application state is included in a first application, and wherein the third application state is included in the first application.

9. The method of claim 1, wherein the second application state is included in a first application, and wherein the third application state is included in a second application that is different than the first application.

10. The method of claim 1, wherein the request is received from the user device, and wherein transmitting the selected action link comprises transmitting the selected action link to the user device.

11. The method of claim 10, wherein the request indicates that the first application state is currently accessed on the user device.

12. The method of claim 1, wherein the request includes data associated with a search result on the user device.

13. The method of claim 1, wherein the server is a first server, wherein the request is received from a second server in communication with the user device, and wherein transmitting the selected action link comprises transmitting the selected action link to the second server.

14. The method of claim 13, wherein the second server is a search server, wherein the entity is associated with a search result generated by the search server, and wherein the first application state is associated with the search result.

15. The method of claim 1, wherein the server is a search server, wherein the request is an action request, and wherein the method further comprises:
receiving, at the search server, a search request from the user device, the search request including the user ID;
generating, at the search server, a set of search results based on the search request, wherein one of the search results is a preliminary search result that includes the entity identification data, and wherein the preliminary search result includes a result link that is configured to cause the user device to access the first application state;
generating, at the search server, the action request; and
generating, at the search server, a completed search result by including the selected action link in the preliminary search result, wherein transmitting the selected action link comprises transmitting the selected action link in the completed search result to the user device.

16. A system comprising:
one or more storage devices configured to store:
a first action link that is configured to cause a user device to access a first application state associated with an entity, wherein the first action link is associated with a first action identifier (ID) that indicates functionality of the first application state; and
a second action link that is configured to cause the user device to access a second application state associated with the entity, wherein the second action link is associated with a second action ID that indicates functionality of the second application state; and
one or more processing units that execute computer-readable instructions that cause the one or more processing units to:
receive a request that includes entity identification data associated with a third application state, wherein the entity identification data identifies the entity, and wherein the request includes a user identifier (ID) that identifies the user device;
identify the first action link based on the entity identification data;
identify the second action link based on the entity identification data;
determine a first usage value and a second usage value based on the user ID, wherein the first usage value indicates a number of times the user device has accessed application states associated with the first action ID, and wherein the second usage value indicates a number of times the user device has accessed application states associated with the second action ID;
score the first action link and the second action link based on the first usage value and the second usage value, respectively;
select one of the first and second action links based on the scores associated with the first and second action links; and
transmit the selected action link.

17. The system of claim 16, wherein the first usage value indicates how often application states with the first action ID were accessed relative to how often a set of additional action IDs were accessed, and wherein the second usage value indicates how often application states with the second action ID were accessed relative to how often the set of additional action IDs were accessed.

18. The system of claim 16, wherein the first usage value indicates a number of times the user device has accessed application states associated with the first action ID using the application that includes the first application state, and wherein the second usage value indicates a number of times the user device has accessed application states associated with the second action ID using the application that includes the second application state.

19. The system of claim 16, wherein the first application state is included in a first application, wherein the second application state is included in a second application, wherein the first usage value indicates a number of times the user device has accessed application states associated with the first action ID using the first application relative to a number of times the user device accessed other additional action IDs using other additional applications, and wherein the second usage value indicates a number of times the user device has accessed application states associated with the second action ID using the second application relative to a number of times the user device accessed the other additional action IDs using the other additional applications.

20. The system of claim 16, wherein the request includes geolocation data that indicates a current geolocation of the user device, and wherein the one or more processing units are configured to:
determine the first usage value based on the user ID and the current geolocation, wherein the first usage value indicates a number of times the user device has accessed application states associated with the first action ID when the user was located in the current geolocation; and
determine the second usage value based on the user ID and the current geolocation, wherein the second usage value indicates a number of times the user device has accessed application states associated with the second action ID when the user was located in the current geolocation.

21. The system of claim 16, wherein the request includes geolocation data that indicates a current geolocation of the user device, and wherein the one or more processing units are configured to:
determine the distance between the user device and the entity based on the current geolocation;
score the first action link based on the first usage value and the determined distance; and
score the second action link based on the second usage value and the determined distance.

22. The system of claim 16, wherein the one or more processing units are configured to:
determine the first usage value based on the user ID and the current time of day, wherein the first usage value indicates a number of times the user device has accessed application states associated with the first action ID during the current time of day; and
determine the second usage value based on the user ID and the current time of day, wherein the second usage value indicates a number of times the user device has accessed application states associated with the second action ID during the current time of day.

23. The system of claim 16, wherein the first application state is included in a first application, and wherein the second application state is included in the first application.

24. The system of claim 16, wherein the first application state is included in a first application, and wherein the second application state is included in a second application that is different than the first application.

25. The system of claim 16, wherein the request is received from the user device, and wherein the one or more processing units are configured to transmit the selected action link to the user device.

26. The system of claim 25, wherein the request indicates that the third application state is currently accessed on the user device.

27. The system of claim 16, wherein the request includes data associated with a search result on the user device.

28. The system of claim 16, wherein the request is received from a server in communication with the user device, and wherein the one or more processing units are configured to transmit the selected action link to the server.

29. The system of claim 28, wherein the server is a search server, wherein the entity is associated with a search result generated by the search server, and wherein the third application state is associated with the search result.

30. The system of claim 16, wherein the request is an action request, and wherein the one or more processing units are configured to:
receive a search request from the user device, the search request including the user ID;
generate a set of search results based on the search request, wherein one of the search results is a preliminary search result that includes the entity identification data, and wherein the preliminary search result includes a result link that is configured to cause the user device to access the third application state;
generate the action request; and
generate a completed search result by including the selected action link in the preliminary search result, wherein transmitting the selected action link comprises transmitting the selected action link in the completed search result to the user device.
